(19) United States
(12) Patent Application Publication
(10) Pub. No.: US 2026/0231016 A1
(43) Pub. Date: Aug. 6, 2026

(54) METHODS, ARCHITECTURES, APPARATUSES AND SYSTEMS FOR NETWORK ENERGY SAVING AWARE CHANNEL STATE INFORMATION FEEDBACK FOR MULTI TRANSMIT/RECEIVE POINT COHERENT TRANSMISSIONS

(71) Applicant: InterDigital Patent Holdings, Inc., Wilmington, DE (US)

(72) Inventors: Umer Salim, Vallauris (FR); Loic Canonne-Velasquez, Dorval (CA); Paul Marinier, Brossard (CA); Janet Stern-Berkowitz, Little Neck, NY (US); Faris Alfarhan, Montreal (CA); Tao Deng, New York, NY (US); Jaya Rao, Montreal (CA)

(21) Appl. No.: 19/043,933

(22) Filed: Feb. 3, 2025

(51) Int. Cl. H04W 52/02; H04L 5/00; H04W 24/10

(52) U.S. Cl. CPC H04W 52/0206; H04L 5/0035; H04W 24/10

(57) ABSTRACT

Methods, architectures, apparatuses, and systems directed to network energy aware channel state information feedback for multi-transmit/receive point (TRP) transmissions are described herein. In an embodiment, a wireless transmit/receive unit (WTRU) may include receiving network configuration information for coherent joint transmission. The method may include determining a set of constrained precoding matrices for coherent joint transmission satisfying any of (i) a first constraint associated with a nominal number of TRPs, (ii) a second constraint associated with a nominal number of antenna panels and (iii) a third constraint associated with a nominal number of spatial beams per layer. The method may include selecting a constrained precoding matrix from the set of constrained precoding matrices based on a performance loss associated with the constrained precoding matrix satisfying a performance loss constraint. The method may include transmitting reporting information indicating the selected constrained precoding matrix and the performance loss.

### TECHNICAL FIELD

The present disclosure is generally directed to the fields of communications, software and encoding, including methods, architectures, apparatuses, and systems directed to network energy saving (NES) aware channel state information (CSI) feedback for multi transmit/receive point (TRP) transmissions.

### BACKGROUND

In Release (Rel)-17, fifth generation (5G) new radio (NR) introduced enhancements to the channel state information (CSI) reporting framework to support a more efficient reporting setting for multiple TRPs in non-coherent joint transmission. In coherent joint transmission (CJT), more than one TRP may transmit simultaneously to a wireless transmit/receive unit (WTRU). Embodiments described herein have been designed with the foregoing in mind.

### SUMMARY

Methods, architectures, apparatuses, and systems directed to NES aware CSI feedback for multi-TRP transmissions are described herein. In an embodiment, a wireless transmit/receive unit (WTRU) is described. The WTRU may include circuitry including any of a transmitter, a receiver, a processor, and memory. The WTRU may be configured to receive network configuration information for coherent joint transmission. In various embodiments, the network configuration information may indicate a performance loss constraint and any of (i) a nominal number of transmit/receive point (TRPs) within a plurality of TRPs, (ii) a nominal number of antenna panels within a plurality of antenna panels per TRP, and (iii) a nominal number of spatial beams per layer. The WTRU may be configured to determine a set of constrained precoding matrices for coherent joint transmission satisfying any of (i) a first constraint associated with the nominal number of TRPs, (ii) a second constraint associated with the nominal number of antenna panels and (iii) a third constraint associated with the nominal number of spatial beams per layer. The WTRU may be configured to select a constrained precoding matrix from the set of constrained precoding matrices based on a performance loss associated with the constrained precoding matrix satisfying the performance loss constraint. The WTRU may be configured to transmit reporting information indicating the selected constrained precoding matrix and the performance loss.

In an embodiment, a method implemented in a WTRU is described. The method may include receiving network configuration information for coherent joint transmission. In various embodiments, the network configuration information may indicate a performance loss constraint and any of (i) a nominal number of transmit/receive point (TRPs) within a plurality of TRPs, (ii) a nominal number of antenna panels within a plurality of antenna panels per TRP, and (iii) a nominal number of spatial beams per layer. The method may include determining a set of constrained precoding matrices for coherent joint transmission satisfying any of (i) a first constraint associated with the nominal number of TRPs, (ii) a second constraint associated with the nominal number of antenna panels and (iii) a third constraint associated with the nominal number of spatial beams per layer. The method may include selecting a constrained precoding matrix from the set of constrained precoding matrices based on a performance loss associated with the constrained precoding matrix satisfying the performance loss constraint. The method may include transmitting reporting information indicating the selected constrained precoding matrix and the performance loss.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example joint transmission from multiple TRPs to a WTRU;

FIG. 3 is a diagram illustrating an example WTRU behavior when no precoding matrix satisfies the constraints;

FIG. 4 is a diagram illustrating an example method for NES aware CSI computation and reporting for coherent joint transmissions;

FIG. 5 is a diagram illustrating a scenario where a WTRU may provide CSI feedback for multi-TRP transmission to the network;

FIG. 6 is a diagram illustrating a low load scenario where a WTRU may provide network energy efficient CSI feedback for multi-TRP transmission;

FIG. 7 is a diagram illustrating a high load scenario where a WTRU may provide network energy efficient CSI feedback for multi-TRP transmission; and

FIG. 8 is a diagram illustrating an example method for NES aware CSI feedback for multi-TRP transmissions.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

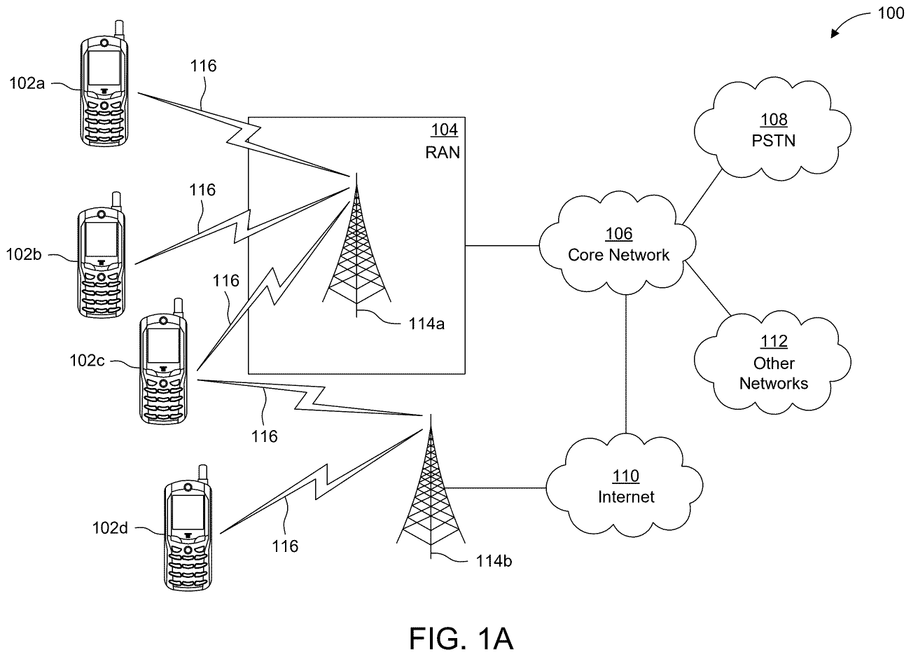

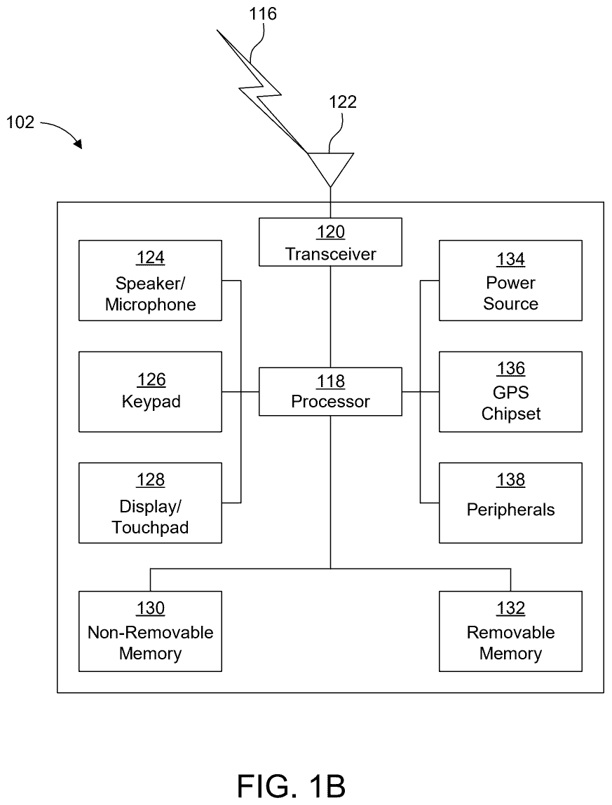

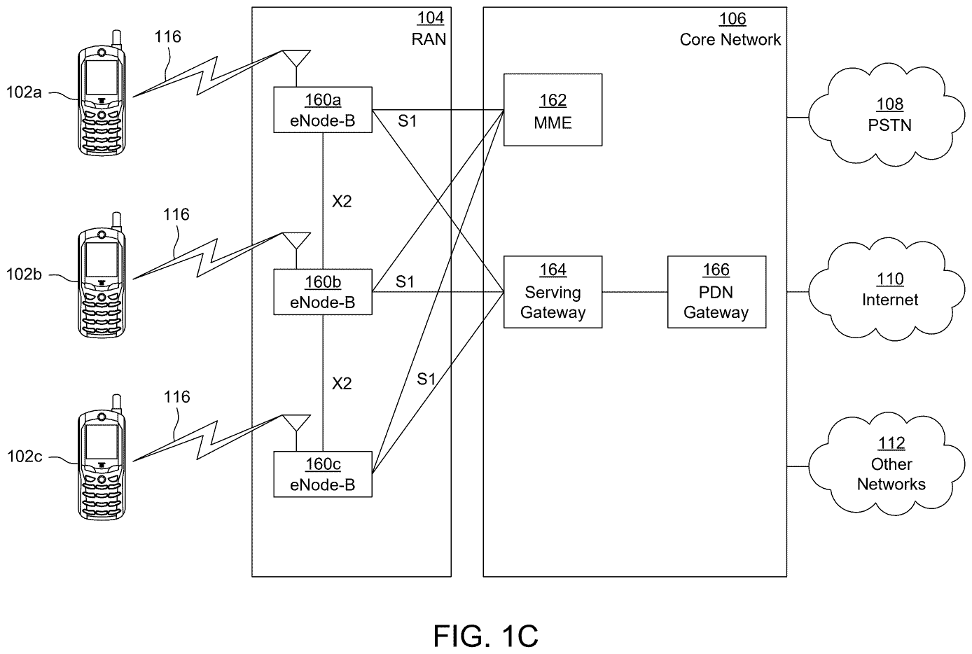

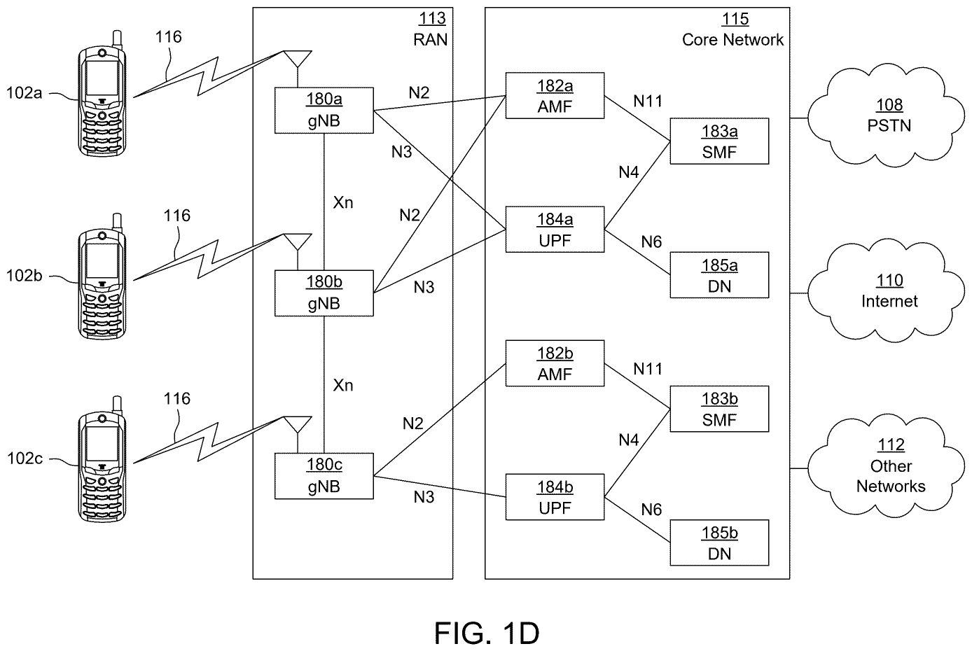

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b, e.g., to customize CN support for WTRUs 102a, 102b, 102c based on the types of services being utilized by WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Throughout embodiments described herein the terms “base station”, “network”, “cell”, and “gNB”, collectively “the network” may be used interchangeably to designate any network element such as e.g., a network element acting as a serving base station. Embodiments described herein are not limited to gNBs and are applicable to any other type of base stations.

For the sake of clarity, satisfying, failing to satisfy a condition, and configuring condition parameter(s) are described throughout embodiments described herein as relative to a threshold (e.g., greater, or lower than) a (e.g., threshold) value, configuring the (e.g., threshold) value, etc. For example, satisfying a condition may be described as being above a (e.g., threshold) value, and failing to satisfy a condition may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

Throughout embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Throughout embodiments described herein, the expression “the WTRU may be configured with a set of parameters” is equivalent or may be used interchangeably with “the WTRU may receive configuration information (e.g., from another network element (e.g., gNB)) indicating a set of parameters”. Throughout embodiments described herein, the expressions “the WTRU may report something”, and “the WTRU may be configured to report something”, is equivalent or may be used interchangeably with “the WTRU may transmit (e.g., reporting) information indicating something”. Throughout embodiments described herein, the expression “the WTRU may provide (/be provided) with a set of parameters (/something)” is equivalent or may be used interchangeably with “the WTRU may transmit (/receive) information indicating a set of parameters (/something)”.

In embodiments described herein, “a” and “an” and similar phrases are to be interpreted as “one or more” and “at least one”. Similarly, any term which ends with the suffix “(s)” is to be interpreted as “one or more” and “at least one”. The term “may” is to be interpreted as “may, for example”.

A symbol “/” (e.g., forward slash) may be used herein to represent “and/or”, where for example, “A/B” may imply “A and/or B”.

In embodiments described herein, “list of”, “set of” and “one or more of” may be used interchangeably.

In embodiments described herein, “identity” and “identifier” may be used interchangeably to refer to how a network element (or a WTRU) may be identified.

In embodiments described herein, a network element may refer to any kind of device including computing resources and networking capabilities, that may be connected to a network. The terms network element and node may be used interchangeably. A network element may be any kind of network infrastructure device and or a WTRU. The architecture depicted at FIG. 1B for a WTRU 102 may be applicable more generally to any kind of network element.

In embodiments described herein, “constraint”, “restriction” and “condition” may be used interchangeably.

In Rel-17, 5G NR introduced enhancements to the channel state information (CSI) reporting framework to support a more efficient reporting setting for multiple TRPs in non-coherent joint transmission (NCJT). CSI resource and reporting settings were addressed with no changes to codebooks.

In coherent joint transmission (CJT), more than one TRP may transmit simultaneously to a WTRU. Data may be available and sent from multiple TRPs at the same time. The precoder may ensure that the signal may be coherently received at the WTRU. The precoder may be applied across multiple antennas located at multiple TRPs. This may involve applying any of (e.g., suitable) amplitude weights, phases and relative phase shifts to antennas at multiple TRPs to enable coherent signal reception/combining at a WTRU.

Rel-18 MIMO specifies improved CSI acquisition for frequency division duplexing (FDD) CJT based on Type II codebook CSI reporting framework. Rel-18 specifies CSI acquisition for CJT targeting the first 5G frequency range (referred to as FR1) and up to four TRPs, assuming ideal backhaul, synchronized TRPs, and with same number of antenna ports across TRPs.

An ideal backhaul refers to TRPs being connected with very high throughput and low latency backhaul links, allowing them to share information (e.g., with each other), e.g., scheduling decisions, user data, channel information, etc. An ideal backhaul may be based on any kind of high-capacity links such as e.g., fiber links.

The initial design of multi-TRP transmissions assumed that the TRPs were ideally synchronized, e.g., their signals may be assumed to have no time delay, phase offset, frequency offset etc. In reality, there may exist time delay, phase offset, frequency offset etc. between the signals transmitted by different TRPs targeting a (e.g., given) WTRU, which may be referred to herein as non-ideal synchronization/non-ideal backhaul.

Rel-19 MIMO is discussing CJT enhancements under non-ideal synchronization and non-ideal backhaul between multiple TRPs with WTRU measurements and reporting of inter-TRP misalignment and frequency/phase offset.

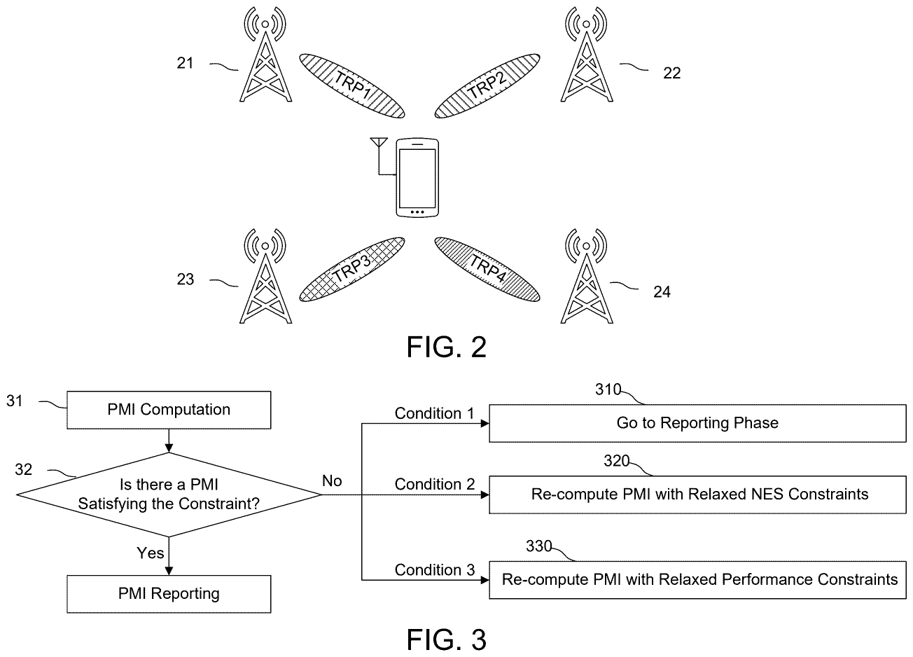

FIG. 2 is a diagram illustrating an example joint transmission from multiple TRPs to a WTRU. As shown in FIG. 2, a first TRP 21, a second TRP 22, a third TRP 23 and a fourth TRP 24 may perform a joint transmission to a WTRU (e.g., the four TRPs 21 22 23 24 may transmit at a same time).

Multi-TRP coherent joint transmission in energy saving networks is described herein.

Third generation partnership project (3GPP) has been specifying series of enhancements to multi-TRP based NCJT and CJT under different aspects targeting (i) accurate CSI feedback, (ii) CSI feedback compression, (iii) CSI for non-ideal backhaul. Network energy saving (NES) aspects have not been considered by 3GPP in multi-TRP based NCJT.

3GPP provided specifications on network energy savings for (i) cell discontinuous transmission (DTx)/discontinuous reception (DRx), (ii) power/spatial domain adaptations for single TRP, (iii) on-demand synchronization signal block (SSB), (iv) on-demand system information block Type 1 (referred to as SIB1), etc. Network energy savings have not been considered yet in the context of multi-TRP transmission scenarios.

Embodiments described herein allow to introduce CSI enhancements enabling multi-TRP coherent joint transmissions with network energy savings.

Embodiments described herein allow to report the CSI (precoding matrix and corresponding parameters) from a subset of TRPs in CJT measurement hypothesis targeting network-energy-efficient CJT.

Rel-18 has specified CSI enhancements for CJT from up to four TRPs. These enhancements are based on Type II codebook supporting up to four layers.

In the current (e.g., Rel-18) framework, the WTRU may provide feedback to maximize its throughput with no consideration of the efficiency of the resulting CJT transmission from network energy saving perspective.

An overview of the restrictions that the network may configure for Type II CJT codebook-based CSI reporting is described herein.

The network may configure the WTRU to restrict (e.g., prevent) the WTRU from reporting (e.g., certain) spatial domain (SD) basis beams, e.g., by configuring a parameter that may be referred to as n1-n2-codebookSubsetRestrictionList-r18.

The network may configure rank restrictions to request feedback for specific ranks, for example, through (e.g., based on, by configuring) the typeII-CJT-RI-Restriction-r18 parameter.

The network may restrict the WTRU to report precoding matrix information (PMI) over (i) all configured TRPs, or (ii) WTRU selected subset of configured TRPs, through (e.g., based on, by configuring) the restrictedCMR-Selection parameter.

The network may configure {1,2,4} combinations of {L1, . . . , L_N_TRP} through (e.g., based on, by configuring) the numberOfSDCombinations (which may also be referred to as numberOfBeams in Rel-15), for controlling (e.g., indicating) the number of spatial beams per TRP incorporating a precoding vector/matrix.

An overview of a NES aware CSI feedback method for multi-TRP coherent transmissions is described herein.

A WTRU may determine a set of constrained pre-coding matrices for joint transmission from one or multiple TRPs (e.g., for coherent joint transmission) satisfying network energy saving constraints, such as e.g., any of: (i) (e.g., minimal) number of TRPs in the joint transmission, (ii) prioritizing TRPs of a (e.g., specific) type e.g., macro or micro TRPs, for joint transmission, (iii) (e.g., minimal) number of antenna panels in the joint transmission, (iv) (e.g., minimal) number of spatial basis beams per layer, and (v) (e.g., minimal) number of ports per transmission layer. The WTRU may estimate the performance loss for a (e.g., each) constrained precoding matrix with regards to the unconstrained precoding matrix. The WTRU may report the determined constrained precoding matrix, and relative performance loss to the network.

A spatial domain filter is described herein.

In an example, a WTRU may transmit or receive a physical channel or reference signal according to at least one spatial domain filter. The term “beam” may be used to refer to a spatial domain filter. In embodiments described herein the terms “beam”, “spatial domain”, “spatial beam” and “spatial domain filter” may be used interchangeably.

The WTRU may transmit a physical channel or a signal using the same spatial domain filter as the spatial domain filter used for receiving any of a reference signal (RS) (such as e.g., a CSI-RS) and a synchronization signal (SS) block (SSB). The WTRU transmission may be referred to as “target”, and the received RS/SS block may be referred to as “reference” or “source”. The WTRU may be said to transmit the target physical channel or signal according to a spatial relation with a reference to a RS/SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. The WTRU may be said to transmit the first (target) physical channel or signal according to a spatial relation with a reference to the second (reference) physical channel or signal.

In an example, a spatial relation may be implicit, configured by radio resource control (RRC) layer or signaled (e.g., indicated) by any of media access control (MAC) layer control element (CE) and downlink (DL) control information (DCI). For example, a WTRU may implicitly transmit physical uplink shared channel (PUSCH) and demodulation reference signal (DMRS) of PUSCH according to the same spatial domain filter as a sounding reference signal (SRS) indicated by an SRS resource indicator (SRI) indicated in DCI or configured by RRC. In another example, a spatial relation may be configured by RRC for an SRI or signaled by MAC CE for a physical uplink control channel (PUCCH). Such spatial relation may also be referred to as a “beam indication”.

The WTRU may receive a first (target) downlink channel or signal according to the same spatial domain filter or spatial reception parameter as a second (reference) downlink channel or signal. For example, such association may exist between a physical channel such as physical downlink control channel (PDCCH) or physical downlink shared channel (PDSCH) and its respective DMRS. In an example, the first and second signals may be reference signals, and such association may exist when the WTRU is configured with a quasi-colocation (QCL) assumption type D between corresponding antenna ports. Such association may be configured as a transmission configuration indicator (TCI) state. A WTRU may be indicated an association between a CSI-RS or SSB and a DMRS by an index to a set of TCI states configured by RRC and/or signaled by MAC CE. Such indication may also be referred to as a “beam indication”.

In embodiments described herein, the term “RS” may be interchangeably used with one or more of “RS resource”, “RS resource set”, “RS port” and “RS port group”.

In embodiments described herein, the term “RS” may be interchangeably used with one or more of “SSB”, “CSI-RS”, “SRS” and “DMRS”.

A TRP is described herein.

In embodiments described herein, a TRP (e.g., transmission and reception point) may be interchangeably used with one or more of transmission point (TP), reception point (RP), radio remote head (RRH), distributed antenna (DA), base station (BS), a sector (of a BS), and a cell (e.g., a geographical cell area served by a BS). In embodiments described herein, multi-TRP may be interchangeably used with one or more of MTRP, M-TRP, and multiple TRPs.

A WTRU may be configured with different types of TRPs. The WTRU may be configured with macro TRPs and/or micro TRPs. More generally, the WTRU may be configured with a first type of TRPs (referred to as Type 1 TRPs) and a second type of TRPs (referred to as Type 2 TRPs).

In an example, Type 1 TRPs may correspond to any of macro TRPs, more capable TRPs (e.g., more hardware/antenna/power), coverage providing TRPs, fully awake TRPs. Type 1 TRPs may also correspond to higher network preference/priority for being used in multi-TRP transmissions. Type 1 TRPs may correspond to any of (i) macro TRPs, (ii) TRPs equipped with a number of Tx and/or Rx and/or RF chains larger than a threshold, (iii) TRPs equipped with power amplifiers with certain characteristics, e.g., max power being larger than a threshold, (iv) TRPs having max transmission power larger than a threshold, (v) a set of TRPs which may be fully awake (e.g., transmitting RS/SSB/CSI-RS with normal periodicity), (vi) a set of TRPs following a specific NES state (e.g., high energy active state), (vii) a set of always on TRPs, (viii) a set of TRPs providing coverage (e.g., which may be transmitting syncs signals periodically and may be used for initial access etc.).

In an example, Type 2 TRPs may correspond to any of (i) micro TRPs, (ii) less capable TRPs (e.g., less hardware/antenna/power), (iii) capacity providing TRPs, (iv) opportunistically awake TRPs. Type 2 TRPs may (e.g., also) correspond to lower network preference/priority for being used in multi-TRP transmissions. Type 2 TRPs may correspond to any of: (i) micro TRPs, (ii) TRPs equipped with a number of Tx and/or Rx and/or RF chains lower than a threshold, (iii) TRPs equipped with power amplifiers with certain characteristics, e.g., max power being lower than a threshold, (iv) TRPs having max transmission power smaller than a threshold, (v) a set of TRPs in a reduced activity phase (e.g., transmitting RS/SSB/CSI-RS with a reduced periodicity), (vi) a set of TRPs following DTx/DRx pattern (e.g., having a periodic pattern with active and inactive intervals), (vii) a set of TRPs following a specific NES state (e.g., a low/reduced activity NES state), (viii) a set of opportunistically on TRPs, (ix) a set of TRPs providing capacity (e.g., the TRPs which may not be for coverage purpose), (x) a set of TRPs which changed their NES state based on WTRU assistance, e.g., the TRPs currently in wake-up state due to WTRU request to wake up these TRPs, (xi) a set of TRPs which changed their NES state based on WTRU based trigger, e.g., UL wake up signal (WUS).

For the sake of clarity, embodiments are described herein with macro TRPs and micro TRPs as examples of types of TRPs associated with different priorities. Embodiments described herein are not limited to macro and micro TRPs and are applicable to any kind of types of TRP to be associated with different priorities/constraints.

Configuration of TRPs, SRS resource indicators (SRIs) and path loss (PL) reference RSs are described herein.

A WTRU may be configured with (e.g., may receive configuration information indicating) one or more TRPs to which the WTRU may transmit and/or from which the WTRU may receive. The WTRU may be configured with one or more TRPs for one or more cells. A cell may be any of a serving cell, a secondary cell, and a supplementary cell.

A WTRU may be configured with at least one RS for (e.g., the purpose of) channel measurement. This RS may be referred to as a channel measurement resource (CMR) and may comprise any of a CSI-RS, SSB, and another downlink RS transmitted from the TRP to a WTRU. A CMR may be configured or associated with a TCI state.

A WTRU may be configured with a CMR or RS group (RSG) which may contain CMR indices transmitted from the same TRP. A (e.g., each) group may be identified by a CMR group index (e.g., group one). A WTRU may be configured with one CMR group per TRP, and the WTRU may receive (e.g., information indicating) a linkage (e.g., association) between one CMR group index and another CMR group index, or between one RS index from one CMR group and another RS index from another group. A WTRU may determine that linked resources may be configured for multi-TRP CJT channel or CSI measurements.

A WTRU may be configured with (e.g., may receive configuration indicating) one or more pathloss (PL) reference groups (e.g., sets) and/or one or more SRS groups, SRS resource indicator (SRI) or SRS resource sets.

A PL reference group may correspond to or may be associated with a TRP. A PL reference group may include, identify, correspond to or be associated with one or more TCI states, SRIs, reference signal sets (e.g. CSI-RS set, SRI sets), control resource set (CORESET) index, and or reference signals (e.g. CSI-RS, SSB).

A WTRU may receive configuration information (e.g., any configuration information described herein). The configuration information may be received from a gNB or TRP. For example, the WTRU may receive configuration information indicating any of one or more TRPs, one or more PL reference groups, and one or more SRI sets. A WTRU may implicitly determine an association between a RS set/group and a TRP. E.g., if the WTRU is configured with two SRS resource sets, then the WTRU may determine to transmit to a first TRP (e.g., TRP1) with SRS in the first resource set, and to a second TRP (e.g., TRP2) with SRS in the second resource set. The configuration information may be received via RRC signaling.

A WTRU may receive an indication of a primary and secondary TRP. In an example, a WTRU may be configured with multiple TRPs. The WTRU may determine that one of the TRP may be the primary or anchor TRP. This designation may be based on a network configuration, or WTRU determination (e.g., based on received signal quality for one TRP being above (e.g., all) other TRP's received signal quality, or above a threshold).

In embodiments described herein, TRP, PL reference group, SRI group, and SRI set may be used interchangeably. In embodiments described herein, the terms “set” and “group” may be used interchangeably.

Grant or assignment properties are described herein.

In embodiments described herein, a property of a grant or assignment may comprise any of (i) a frequency allocation, (ii) an aspect of time allocation, such as a duration, (iii) a priority, (iv) a modulation and coding scheme (MCS), (v) a transport block size, (vi) a number of spatial layers, (vii) a number of transport blocks, (viii) a TCI state/CRI/SRI, wherein any of a TCI state, CRI, SRI may be for a (e.g., each) WTRU's panel if multiple panels are used for an uplink transmission, (ix) a number of repetitions, (x) an indication of whether the repetition scheme is Type A or Type B, (xi) an indication of whether the grant is a configured grant type 1, type 2 or a dynamic grant, (xii) an indication of whether the assignment is a dynamic assignment or a semi-persistent scheduling (configured) assignment, (xiii) a configured grant index or a semi-persistent assignment index, (xiv) a periodicity of a configured grant or assignment, (xv) a channel access priority class (CAPC), (xvi) any parameter provided in a DCI, by MAC or by RRC for scheduling the grant or assignment, (xvii) an indication of whether the grant is for single-TRP transmission or multi-TRP transmission, (xviii) an indication of whether the grant is for uplink transmission from single WTRU panel (TxSP) or simultaneous uplink transmission from multiple WTRU panels (STxMP), (xix) an indication of whether the grant is for CJT or NCJT transmission.

CSI components are described herein.

A WTRU may report a subset of channel state information (CSI) components, where CSI components may correspond to any of a CSI-RS resource indicator (CRI), a SSB resource indicator (SSBRI), an indication of a panel used for reception at the WTRU (such as a panel identity or group identity), measurements such as layer one (L1) reference signal received power (L1-RSRP), L1 signal to noise ratio (L1-SINR) taken from SSB or CSI-RS (e.g., any of cri-RSRP, cri-SINR, ssb-Index-RSRP, ssb-Index-SINR), and any other channel state information such as any of rank indicator (RI), channel quality indicator (CQI), precoding matrix indicator (PMI), layer index (LI), and the like.

Codebook types for CSI reporting are described herein.

A WTRU may be configured with a type of codebook for PMI reporting. A codebook may determine a set of precoders. A (e.g., each) precoder may indicate the amplitude and phase shift to apply to the modulation symbols before transmitting it on antenna elements/antenna ports.

In one example, the WTRU may be configured with a Type I codebook as described, for example, in NR Rel-15. The WTRU may report a selected beam and a phase indication for dual polarized beam combining. The beam information may be wideband, and the phase may be reported per sub-band.

In another example, the WTRU may be configured with a Type II codebook as described, for example, in NR Rel-15. The Type II codebook may be based on a wideband CSI (referred to as W1) and a narrowband CSI (referred to as W2). In this process, W1 may represent a preferred set of dual-polarized beams for a (e.g., each) transmission layer. W1's structure may comprise a matrix with a first number (L1) of columns corresponding to the same first number L1 of spatial beams (e.g., L1 basis vectors), and a second number (R) of rows corresponding to the basis length. The set of spatial beams used for constructing W1 may be referred to as a spatial basis of beams. W1 may be based on a block-diagonal structure to represent the orthogonal polarization of transmit antenna set up. W1 CSI may include wideband coefficient for indication of a preferred power setting per spatial beam. The W2 CSI may include any of additional amplitude information, delay information and co-phasing information for indication of preferred linear beam combining for cross-polarized antennas. The reporting of all or a subset of W2 CSI components may be per sub-band basis. The sub-band configuration may be part of CSI reporting configuration.

For multi-TRP transmissions, the W2 may additionally include any of the amplitude, phase, delay etc. on TRP basis. These components may be reported separately per TRP or integrated within a combined PMI (W1 and W2).

The WTRU may be configured to select the type of the codebook based on configuration.

In one example, the WTRU may be configured to select the type of the codebook based on a number of beams, e.g., based on indicated/configured or WTRU determined number of beams for CSI reporting.

The WTRU may be configured to apply compression techniques to the codebooks, e.g., any of compression in frequency domain (as described in NR Rel-16), compression in spatial domain, compression in temporal domain etc.

In one example, the WTRU may be configured to report PMI for a pre-defined set of spatial domain basis vectors, e.g., discrete Fourier transform (DFT) based basis, as used in Type I and Type II. The WTRU may be configured/indicated to use different basis instead of DFT basis.

In one example, the Type II codebook may be configured as a port-selection codebook, where the W1 matrix may be used to indicate port indices from the measured CSI-RS resource associated with the CSI report. The WTRU may be configured to report PMI based on port selection where the CSI-RS ports may be used by the WTRU to determine a combination for PMI reporting.

CSI feedback transmission (e.g., reporting) is described herein.

A WTRU may transmit a CSI report. The WTRU may transmit a CSI report with (e.g., including) one or more CSI components. The WTRU may transmit a CSI report to the network in the uplink direction. The WTRU may transmit a CSI report to the network using physical uplink control channel (PUCCH) and/or physical uplink shared channel (PUSCH). The WTRU may be configured to transmit the report periodically, semi-persistent or in aperiodic manner.

In embodiments described herein the terms precoding matrix indicator (PMI), precoding matrix information and precoding matrix may be used interchangeably.

Configuration for network energy efficient multi-TRP operation is described herein.

WTRU configuration for network energy efficient multi-TRP operation is described herein.

A WTRU may be configured for multi-TRP operation. The WTRU may be configured for multi-TRP operation in the downlink (DL) and/or in the uplink (UL) direction. The WTRU may be configured with the network energy efficient multi-TRP operation.

For network energy efficient multi-TRP operation, the WTRU may be configured with any of (i) configurations of measurements and measurement resources from multiple TRPs, (ii) a configuration for NES aware CSI computation, (iii) a configuration for network energy saving constraints for PMI determination from multiple TRPs, (iv) a configuration for performance constraints for PMI determination from multiple TRPs, (v) a configuration when no PMI satisfy NES and performance constraints simultaneously, and (vi) configurations for NES aware CSI reporting.

The details for these configurations are further described herein.

A WTRU configuration for CSI measurement resources from multiple TRPs is described herein.

A WTRU may be configured for channel state information (CSI) measurements. A WTRU may be configured by the network for CSI measurements from one or more than one TRPs. The WTRU may be configured with reference signals (RSs) for CSI measurements from multiple TRPs. The WTRU may be configured with one or more types of RSs, e.g., any of non-pre-coded RSs, pre-coded RSs, etc., for CSI measurements. The WTRU may be configured with any of the following properties for the configured RS: (i) a RS identity, (ii) a resource mapping such as e.g., time location (e.g., OFDM symbols) and frequency location (e.g., physical resource blocks (PRBs) or resource elements (REs) for the RS), (iii) a periodicity of the resource (e.g., for periodic and semi-persistent resources), (iv) a resource offset, such as e.g., a time offset to locate the start of the RS in time (e.g., in suitable units of slots and/or symbols, etc.), (v) a TRP identity, e.g., for the TRP associated with the RS, (vi) a cell identifier (ID) associated with the RS), (vii) a resource set identity that RS resource may belong to, (viii) a bandwidth part associated with the RS, (ix) a time domain behavior, such as e.g., aperiodic, semi-persistent, periodic, (x) a power control offset for PDSCH, (xi) a power control offset against SSB, (xii) QCL information, e.g., by indicating one or multiple TCI states, (xiii) a scrambling identity for the scrambling applied to the RS, (xiv) a sub-carrier spacing, and (xv) a cyclic prefix (e.g., normal or extended).

The network may provide (e.g., transmit) additional configuration (e.g., information) for CSI resource sets or CSI resource groups where those configurations may be applicable to one TRP or a set of TRPs.

In an example, additional configuration information may include/indicate a CSI resource set identity.

In an example, additional configuration information may include/indicate a TRP identity e.g., associated with (e.g., all) the RS indicated within the group. The network may indicate one or more TRP identities.

In an example, additional configuration information may include/indicate a TRP type. This may provide/indicate the type of the TRP for a (e.g., each) indicated TRP identity which may indicate any of a (i) micro TRP or macro TRP, (ii) coverage TRP or capacity TRP, (iii) UL/DL TRP, DL only TRP, UL only TRP etc. (iv) always on TRP or opportunistically on TRP.

In an example, additional configuration information may include/indicate a NES state for the indicated TRP identities. The NES state may provide an indication of network energy saving state of the resource set. In one example, NES state may be associated with the TRP. In some examples, the NES state may be determined by the WTRU based on the TRP type, e.g., one NES state for micro TRP, and another NES state for macro TRP.

In an example, additional configuration information may include/indicate a target NES state: The target NES state may provide an indication of the desired NES state under which the network may expect to operate this resource set and/or associated one or more TRPs. In some examples, the WTRU may determine the target NES state based on the type of TRPs. For example, the WTRU may determine a desired NES state of “opportunistically on” or “sleep” for micro TRPs, and a state of “always on” for macro TRPs, etc.

In an example, additional configuration information may include/indicate a power control offset associated with the TRP (e.g., if specified). For example, the WTRU may know default values to apply which may be based on the type of the TRP, e.g., the TRP being micro or macro TRP.

In an example, additional configuration information may include/indicate a cell ID.

In an example, additional configuration information may include/indicate a list of RS resources belonging to the resource set, such as e.g., a list of RS identities.

In an example, additional configuration information may include/indicate a mapping (e.g., association) of RS resource IDs with the TRP ID: If the resource set is configured for more than one TRP, the network may configure the mapping (e.g., association) of RS resources and TRPs. For example, the mapping (e.g., association) may be configured as part of the RS resource configuration.

In an example, additional configuration information may include/indicate a time domain behavior such as e.g., aperiodic, semi-persistent, periodic.

The network may provide the linkage/pairing of RS resources for CJT CSI reporting. In one example, the network may configure different CSI resource sets for different TRPs and may provide linkage of resources from one resource set to the other. In one example, there may be implicit linkage or pairing of resources for different resource sets.

In one example, the network may provide the configuration for linking/pairing RS resources for (e.g., all) TRPs. The pairing may be between (e.g., all) the configured TRPs, which may be candidates for CJT. The RS pairing may be configured among a subset of TRPs, e.g., RS pairing sets for two TRPs, three TRPs, four TRPs etc.

WTRU configuration for NES aware CSI computation is described herein.

A WTRU may be configured to compute and report CSI feedback. The WTRU may be configured to compute and report NES aware CSI feedback. The WTRU may be configured to determine PMI based on channel state information (CSI) measurements for energy aware CJT from a set of TRPs.

For NES aware CSI computation, the WTRU may be configured with any of the following configurations: (i) NES constraints for CSI/PMI computation/reporting, (ii) performance constraints for CSI/PMI computation/reporting, and (iii) handling when no PMI satisfy performance and NES constraints simultaneously.

The details for the above configurations are further described herein.

WTRU configuration for network energy saving constraints for PMI determination from multiple TRPs is described herein.

A WTRU may be configured for channel state information (CSI) measurements for energy aware CJT from a set of TRPs. The WTRU may be configured to report PMI enabling multi-TRP transmission (e.g., CJT) for saving network energy. The WTRU may be configured with different energy saving constraints/restrictions to save network energy at different levels, e.g., by reducing the number of TRPs in the joint transmission, by reducing the number of antenna panels per TRP, by reducing the number of spatial beams per transmission layer, by reducing the number of antenna ports per layer or per TRP or per joint transmission, etc. The WTRU may be configured with any of the following network energy saving (NES) restrictions/constraints.

In an example, the WTRU may be configured with an upper bound (e.g., max) number of TRPs for PMI determination: The WTRU may be configured with a number of TRPs that may not be exceeded for PMI computation. This number may be equal or smaller than the total number of TRPs configured for CSI measurements.

In an example, the WTRU may be configured with a baseline/nominal number of TRPs for PMI determination. This may be a number of TRPs (e.g., a nominal number of TRPs to start computing CJT PMI). This may be considered as the baseline or nominal number of TRPs that the network may be requesting the CJT PMI from the WTRU if it satisfies other constraints. The WTRU may (e.g., be configured to) compute PMI with more TRPs if the WTRU cannot determine a PMI meeting the performance requirements with baseline/nominal number of TRPs.

In an example, the WTRU may be configured with an upper bound (e.g., max) number of Type 1 TRPs for PMI determination: The WTRU may be configured with a number of Type 1 (e.g., macro) TRPs that may not be exceeded for PMI computation. This number may be equal or smaller than the total number of Type 1 TRPs configured for CSI measurements.

In an example, the WTRU may be configured with a baseline/nominal number of Type 1 TRPs for PMI determination. This may be a number of Type 1 TRPs (e.g., a nominal number of Type 1 TRPs to start computing CJT PMI). This may be considered as the baseline or nominal number of Type 1 TRPs that the network may be requesting the CJT PMI from the WTRU if the WTRU satisfies other constraints. The WTRU may (e.g., be configured to) compute PMI with larger number of Type 1 TRPs if the WTRU cannot determine a PMI meeting the performance requirements with baseline/nominal number of Type 1 TRPs. In one example, Type 1 TRPs may correspond to more capable TRPs, they may correspond to any of (i) macro TRPs, (ii) TRPs equipped with Tx and/or Rx and/or RF chains more than a threshold, (iii) TRPs equipped with power amplifiers with certain characteristics, e.g., max power being larger than a threshold, and (iv) TRPs having (e.g., max) transmission power larger than a threshold.

In an example, the WTRU may be configured with an upper bound (e.g., max) number of Type 2 TRPs for PMI determination: The WTRU may be configured with a number of Type 2 (e.g., micro) TRPs that may not be exceeded for PMI computation. This number may be equal or smaller than the total number of Type 2 TRPs configured for CSI measurements.

In an example, the WTRU may be configured with a baseline/nominal number of Type 2 TRPs for PMI determination. This may be a number of Type 2 TRPs (e.g., a nominal number of Type 2 TRPs to start computing CJT PMI). This may be considered as the baseline or nominal number of Type 2 TRPs that the network may be requesting the CJT PMI from the WTRU if the WTRU satisfies other constraints. The WTRU may (e.g., be configured to) compute PMI with larger number of Type 2 TRPs if the WTRU cannot determine a PMI meeting the performance requirements with baseline/nominal number of Type 2 TRPs. In one example, Type 2 TRPs may correspond to less capable TRPs, they may correspond to any of: (ii) micro TRPs, (ii) TRPs equipped with Tx and/or Rx and/or RF chains smaller than a threshold, (iii) TRPs equipped with power amplifiers with certain characteristics, e.g., (e.g., max) power being smaller than a threshold, and (iv) TRPs having (e.g., max) transmission power smaller than a threshold.

In an example, the WTRU may be configured with a baseline/nominal number of Type 2 TRPs for PMI determination with a specific relation to the Type 1 TRPs. This may be a number of Type 2 TRPs (e.g., a nominal number of Type 2 TRPs to start computing CJT PMI) with a specific relation to a (one/any/all) Type 1 TRPs. This may be considered as the baseline or nominal number of Type 2 TRPs that the network may be requesting the CJT PMI from the WTRU if the WTRU satisfies other constraints. The WTRU may be configured to compute PMI with larger number of Type 2 TRPs if the WTRU cannot determine a PMI meeting the performance requirements with baseline/nominal number of Type 2 TRPs. The Type 2 TRPs indicated here may have a specific relation to one or more Type 1 TRPs where the TRP identities and the relation may be part of the configuration. The WTRU may receive any of the following indications as the relation between Type 2 and Type 1 TRPs: (i) one or more Type 2 (Micro) TRPs sharing the same control unit (CU) with one or more Type 1 (macro) TRP and their identities, and (ii) one or more Type 2 (Micro) TRPs having a better/ideal backhaul with one or more Type 1 (macro) TRP and their identities. This constraint may allow the network to configure WTRU prioritization (or de-prioritization) of micro TRPs associated or not associated with one or more macro TRPs for multi-TRP joint transmissions.

In an example, the WTRU may be configured with a baseline/nominal number of spatial domain beams per layer for PMI determination. This may be a number of spatial domain beams per layer (e.g., a nominal number of spatial beams to start computing CJT PMI). This may be considered as the baseline or nominal number of spatial beams per layer that the network may be requesting the CJT PMI from the WTRU if the WTRU satisfies other constraints. The WTRU may (e.g., be configured to) compute PMI with a number of spatial beams per layer higher than the configured baseline/nominal number if the WTRU cannot determine a PMI meeting the performance requirements with baseline/nominal number spatial beams per layer.

In an example, the WTRU may be configured with an upper bound (e.g., max) number of ports per layer for PMI determination: The WTRU may be configured with a number of ports per layer that WTRU may not exceed for PMI computation and reporting. This number may be equal or smaller than the total number of ports that the network may configure/indicate to the WTRU for CSI measurements. This parameter may be configured to the WTRU when for example the WTRU is configured to report PMI with port selection codebook.

In an example, the WTRU may be configured with a baseline/nominal number of ports per layer for PMI determination. This may be a number of ports per layer (e.g., a nominal number of ports per layer to start computing CJT PMI). This may be considered as the baseline or nominal number of ports per layer. The WTRU may use a number of ports larger than the nominal number for PMI computation and reporting if the WTRU cannot determine a PMI satisfying performance constraints with the nominal number of ports.

In an example, the WTRU may be configured with an upper bound (e.g., max) number of antenna panels for PMI determination: The WTRU may be configured with a number of antenna panels for a TRP that the WTRU may not exceed for PMI computation and reporting. This number may be equal or smaller than the total number of antenna panels that the network may configure/indicate to the WTRU for CSI measurements. The WTRU may be configured with this parameter individually (e.g., with a specific value) per configured TRP, or a same value may be configured for (e.g., all) TRPs.

In an example, the WTRU may be configured with a baseline/nominal number of antenna panels for PMI determination. This may be a number of antenna panels for a TRP to start computing CJT PMI. This may be considered as the baseline or nominal number of antenna panels. The WTRU may use a number of antenna panels larger than the nominal number for PMI computation and reporting if the WTRU cannot determine a PMI satisfying performance constraints with the nominal number of antenna panels.

WTRU configuration for performance constraints for PMI determination from multiple TRPs is described herein.

A WTRU may be configured for PMI determination. The WTRU may be configured to determine PMI based on channel state information (CSI) measurements for energy aware CJT from a set of TRPs. The WTRU may be configured to determine PMI under a set of performance constraints. The WTRU may be configured with any of the following performance restrictions/constraints.

In an example, the WTRU may be configured with a target rank (referred to herein as R) e.g., the reported rank of the precoding matrix may not be less than a threshold R.

In an example, the WTRU may be configured with a performance loss constraint (PLC): The WTRU may be configured to determine and report PMI such that the estimated performance loss of the constrained precoding matrix with regards to (e.g., relative to) the unconstrained precoding matrix may be less than a threshold PLC. The WTRU may determine the performance loss of a determined NES constrained PMI using a method as indicated/configured by the network. The performance loss may correspond to any of (i) the throughput difference of the constrained vs unconstrained PMI, (ii) the energy difference of effective channel between the constrained and unconstrained PMI, where the effective channel may be the matrix of precoding and radio channel), (iii) the difference of sum of squared eigen values of composite channel (precoding and radio channel) between the constrained and unconstrained PMI, and (iv) the energy difference of the largest Eigen value between the constrained and unconstrained PMI.

In an example, the WTRU may be configured with a quality/reliability constraint. The reported (e.g., selected) PMI may have quality better than a (e.g., given) threshold, e.g., the CQI associated with the reported precoding matrix may not exceed a threshold. In one example, the constraint may be over the quality/reliability difference between the constrained PMI and unconstrained PMI, e.g., the CQI difference between the two may be smaller than another threshold.

In an example, the WTRU may be configured with a throughput constraint: The reported (e.g., selected) PMI may have a throughput better than a (e.g., given) threshold, e.g., the CQI associated with the reported precoding matrix may exceed a threshold. In one example, the constraint may be over the throughput difference between the constrained PMI and unconstrained PMI, e.g., the CQI difference between the two may be smaller than another threshold.

In an example, the WTRU may be configured with a number (referred to as n) of joint precoding matrices to report where n may be configured as any of the lower bound (e.g., min), upper bound (e.g., max), and precise number of reported precoding matrices (e.g., 1, 2, . . . ).

WTRU configuration when no PMI satisfy NES and performance constraints simultaneously is described herein.

A WTRU may be configured to report NES aware CSI/PMI. The WTRU may be configured to determine PMI for CJT under a set of NES constraints according to any embodiment described herein. The WTRU may be further configured with a set of performance constraints that constrained PMI may be expected to satisfy.

A WTRU may be configured with a behavior in case none of the PMI satisfy simultaneously NES and performance constraints. The WTRU may be configured with one or more of the following behaviors in this case.

In an example, in case none of the PMI satisfy simultaneously NES and performance constraints, the WTRU may report the unconstrained PMI.

In another example, in case none of the PMI satisfy simultaneously NES and performance constraints, the WTRU may report any of (i) the NES constrained PMI with smallest performance loss, e.g., smallest throughput loss compared to the unconstrained PMI, (ii) the NES constrained PMI with the largest CQI value, (iii) the NES constrained PMI with the largest rank, etc.

In another example, in case none of the PMI satisfy simultaneously NES and performance constraints, the WTRU may relax the NES constraints: In one example, the WTRU may be configured to relax the NES constraints if none of the determined PMI satisfy the performance constraints. The WTRU may be configured with any one or more of the following: (i) increase the number of TRPs in the CJT set (e.g., the WTRU may increase the number of TRPs by one more than the nominal/baseline number of TRPs indicated by the network), (ii) increase the number of antenna panels per TRP (e.g., the WTRU may increase the number antenna panels per TRP by one more than the nominal/baseline number of antenna panels configured by the network, (iii) increase the number of spatial domain basis beams per layer (e.g., the WTRU may increase the number of basis beams per layer by one more than the nominal/baseline number of spatial beam per layer configured by the network) and (iv) increase the number of ports per layer (e.g., the WTRU may increase the number of ports per layer by one more than the nominal/baseline number of ports per layer configured by the network). When the WTRU relaxes the NES constraints, the WTRU may (e.g., be configured to) re-compute the NES constrained PMI matrices under the relaxed NES constraints. The WTRU may then re-evaluate if the constrained PMI satisfy the performance constraints. If they do, the WTRU may (e.g., be configured to) report the PMI to the network as per the reporting configuration. Otherwise, the WTRU may (e.g., be configured to) perform a number of iterations relaxing NES constraints, until the WTRU may find the PMI satisfying the performance constraints or the number of iterations may have reached to a limit.

When the WTRU is configured to relax the NES constraints, the WTRU may be configured with an order/priority ordering to be used to relax the constraints in an (e.g., each) iteration of PMI computation. As an example, the WTRU may be configured to first increase the number of antenna panels and re-compute the PMI. If antenna panels reach the upper bound (e.g., maximum, total) number, the WTRU may be configured to increase the number of spatial beams per layer and re-compute the PMI. If the spatial beams per layer reach the maximum number, the WTRU may increase the number of TRPs to re-compute the PMI. In this example PMI re-computation priority ordering may be based on (i) number of antenna panels first, (ii) then number of spatial beams per layer, and finally (iii) number of TRPs. The WTRU may be configured to use different ordering, e.g., (i) number of TRPs first, (ii) then number of antenna panels, and (iii) then number of spatial beams per layer.

In another example, in case none of the PMI satisfy simultaneously NES and performance constraints, the WTRU may relax the performance constraints: In one example, the WTRU may be configured to relax the performance constraints if none of the determined PMI satisfy the performance constraints. In one example, the WTRU may (e.g., be configured to) relax the performance constraints if the WTRU has reached the limit on certain parameters, e.g., the PMI computation may be using the upper bound (e.g., max) number of TRPs configured/indicated, or the PMI computation may be using the upper bound (e.g., max) number of antenna panels per TRP, or the PMI computation may be using the upper bound (e.g., max) number of spatial beams per layer, or the PMI computation may be using the upper bound (e.g., max) number of ports per layer. When the WTRU is configured to relax the performance constraints, the WTRU may be configured with any one or more of the following: (i) reduce the target rank by one less than configured/indicated rank for which WTRU may be determining PMI, (ii) reduce the target CQI by a configured threshold, where the threshold applied may be be according to a mapping table, in dB, or in another suitable format, and (iii) reduce the target rate/throughput/reliability etc. according to the provided configuration to determine PMI.

In an example, the WTRU may determine to relax the performance constraints. The WTRU may (e.g., be configured to) re-evaluate the NES constrained PMI matrices under the relaxed performance constraints. If the constrained PMI matrices satisfy the relaxed performance constraints, the WTRU may (e.g., be configured to) report the PMI to the network as per the reporting configuration. Otherwise, the WTRU may (e.g., be configured to) perform a number of iterations relaxing performance constraints, until the WTRU may find the PMI satisfying the performance constraints or the number of iterations may have reached to a limit.

WTRU configuration for NES aware CSI reporting is described herein.

A WTRU may be configured to report CSI. The WTRU may be configured to report NES aware CSI for multi-TRP transmissions. The NES aware CSI may comprise any of the CSI/PMI computed under configured NES and performance constraints according to any embodiment described herein.

The WTRU may be configured to report any of the following for NES aware CSI/PMI reporting: (i) a CQI and associated RS resource where CQI may have been computed, (ii) resource indicator (RI) and associated RS resource where RI may have been computed, (iii) PMI and associated RS resource where PMI may have been computed, (iv) RSRP/RSRQ/SINR for the RS resources for which any of the CQI/RI/PMI may be reported.

When the WTRU reports the PMI, the WTRU may (e.g., be configured to) report any of: (i) a PMI based on Type I codebook with parameters (e.g., needed, to be used) to determine the PMI at the network, e.g., any of beam, amplitude, phase, (ii) a PMI based on Type II codebook with (e.g., relevant) parameters (e.g., needed, to be used) to determine the PMI at the network, e.g., any of beams, beam combining parameters, amplitude, phase, etc., and (iii) a PMI based on Type II codebook with port selection with (e.g., relevant) parameters (e.g., needed, to be used) to determine the PMI at the network, e.g., any of ports, port combining parameters, amplitude, phase, etc.

The WTRU may (e.g., be configured to) report ‘p’ PMI determined according to the configuration where ‘p’ may be a configuration parameter and may take an integer value, e.g., 1, 2, etc.

A WTRU may (e.g., be configured to) report unconstrained PMI (e.g., PMI determined with no NES constraints) whenever at least one constrained PMI may be reported.

A WTRU may (e.g., be configured to) report unconstrained PMI (e.g., PMI determined with no NES constraints) in addition to constrained PMI.

A WTRU may (e.g., be configured to) report the degradation of constrained PMI with regards to the unconstrained PMI for a (e.g., each) reported PMI, where the degradation metric may be part of configuration and may include any of: (i) a rank loss, (ii) a rate loss, (iii) a throughput loss, (iv) a reliability loss, etc.

A WTRU may be configured with priorities associated with different components/nature of CSI feedback. The WTRU may be configured with different priority values for CSI part 1 and CSI part 2. The WTRU may be configured with different priority values for constrained CSI/PMI Part 1 and unconstrained CSI/PMI Part1. The WTRU may be configured with different priority values for constrained CSI/PMI Part 2 and unconstrained CSI/PMI Part2. The WTRU may be configured with different values for constrained CSI/PMI Part 1/Part 2 of different PMI when the WTRU is configured to report more than one constrained PMI. The WTRU may be configured to assign priority value to different PMI based on any of the following: (i) the rank of the reported PMI, e.g., the WTRU may be configured to assign higher priority value to higher rank PMI, (ii) the CQI of the reported PMI, e.g., the WTRU may be configured to assign higher priority value to higher reported CQI, (iii) the number of spatial beams used to determine the reported PMI, e.g., the WTRU may be configured to assign higher priority value to PMI computed with least/smaller number of spatial beams, (iv) the estimated performance loss of the reported PMI relative to the unconstrained PMI (e.g., based on the estimated loss in rank, estimated loss in CQI, estimated loss in throughput, estimated loss in energy, etc. as an example, the WTRU may be configured to assign a higher priority value for PMI with smaller/smallest loss etc. the WTRU may be configured with quantized intervals of loss which may be assigned a (e.g., given) priority value), (v) the estimated performance loss of the reported PMI relative to configured thresholds (e.g., based on the estimated loss in rank, estimated loss in CQI, estimated loss in throughput, estimated loss in energy, etc.), and (vi) the difference of number of spatial beams used to determine the reported PMI and the nominal number of spatial beams.

The WTRU may (e.g., be configured to) report the CSI in order of the configured/determined priorities of the CSI components, e.g., the higher/highest priority components may be transmitted first when all CSI parts/components may not be transmitted e.g., due to limited transmission resource.

The WTRU may (e.g., be configured to) drop the CSI in order of the configured/determined priorities of the CSI components, e.g., the lower/lowest priority components may be dropped first when all CSI parts/components may not be transmitted e.g., due to limited transmission resource.

WTRU determination of network energy efficient CSI feedback for multi-TRP operation is described herein.

Measurement of RSs from multiple TRPs is described herein.

A WTRU may receive, and measure RSs. The WTRU may receive, and measure RSs transmitted from one or multiple TRPs. The WTRU may determine the parameters to receive and measure RSs from the CSI configuration. The relevant parameters to receive and measure RSs may comprise of any of: (i) a resource mapping such as e.g., time location (e.g., OFDM symbols) and frequency location (e.g., PRBs or REs) for the RS), (ii) a periodicity of the resource (e.g., for periodic and semi-persistent resources), (iii) a resource offset e.g., the time offset to locate the start of the RS in time (e.g., in suitable units of slots and/or symbols, etc.), (iv) a TRP identity e.g., for the TRP associated with the RS, (v) a cell ID associated with the RS, (vi) a resource set identity that RS resource may belong to, (vii) a bandwidth part associated with the RS, (viii) a time domain behavior (e.g., aperiodic, semi-persistent, periodic), (ix) a power control offset for PDSCH, (x) a power control offset against SSB, (xi) QCL information e.g., by indicating one or multiple TCI states, (xii) a scrambling identity for the scrambling applied to the RS, (xiii) a sub-carrier spacing and (xiv) a cyclic prefix (e.g., normal or extended).

Determination of unconstrained CJT PMI from multiple TRPs is described herein.

A WTRU may determine a precoding matrix. The WTRU may determine a precoding matrix information (PMI) based on the CSI received from one or multiple TRPs. The WTRU may determine a PMI for joint transmission from multiple TRPs. The WTRU may determine a PMI for joint transmission (e.g., coherent joint transmission) from multiple TRPs based on the RSs transmitted by these TRPs. The WTRU may receive and measure the RSs from one or more TRPs based on the network configuration information received for the RS resources transmitted by these TRPs according to any embodiment described herein.

The WTRU may determine a PMI for joint transmission from one or more TRPs based on the RS measurements from a set of configured TRPs. The WTRU may determine a PMI without using/activating the constraints in PMI determination where constraints may be configured according to any embodiment described herein. The PMI determined without (e.g., imposing) the constraints/restrictions is referred to herein as the unconstrained PMI.

The WTRU may determine an unconstrained PMI based on not using/activating any of the following set of constraints: (i) energy saving restrictions/constraints, and (ii) performance restrictions/constraints, where the energy saving constraints and performance constraints in PMI determination may be configured according to any embodiments described herein.

In one example, the WTRU may determine an unconstrained PMI with no NES constraints. In one example, the WTRU may determine an unconstrained PMI with no performance constraints. In one example, the WTRU may determine a first PMI with no NES constraints, and a second PMI with no performance constraints.

In one example, the WTRU may determine an unconstrained PMI based on any of the following: (i) a PMI with no NES/performance constraints over any subset of macro TRPs (e.g., only), (ii) a PMI with no NES/performance constraints over any subset of micro TRPs (e.g., only), (iii) a PMI with no NES/performance constraints over any subset of macro and/or any subset of micro TRPs, and (iv) a PMI with no NES/performance constraints over an anchor (main) macro and a subset of micro TRPs associated with the anchor macro, where the micro TRPs may have some (e.g., particular) relation with the macro TRP. For example, the micro TRPs may share the same distributed unit (DU) and/or control unit (CU) with the macro TRP. For example, the WTRU may know through configuration/signaling that micro TRPs may have backhaul links with the macro of a specific nature, e.g., backhaul links with a certain quality, direct backhaul links etc.

Determination of constrained CJT PMI from multiple TRPs is described herein.

A WTRU may determine a precoding matrix. The WTRU may determine a precoding matrix information/indicator (PMI) based on the CSI received from one or multiple TRPs. The WTRU may determine a PMI for joint transmission from multiple TRPs. The WTRU may determine a PMI for joint transmission (e.g., coherent joint transmission) from multiple TRPs based on the RSs transmitted by these TRPs. The WTRU may receive and measure the RSs from one or more TRPs based on the configuration received for the RS resources transmitted by these TRPs according to any embodiment described herein.

The WTRU may determine a PMI for joint transmission from one or more TRPs based on the RS measurements from a set of configured TRPs. The WTRU may determine a PMI using/activating the constraints in PMI determination where constraints may be configured according to any embodiment described herein. The PMI determined under the constraints/restrictions may be referred to herein as the constrained PMI.

The WTRU may determine a constrained PMI using/activating any of the following set of constraints: (i) energy saving restrictions/constraints, and (ii) performance restrictions/constraints, where the energy saving constraints and performance constraints in PMI determination may be configured according to any embodiment described herein.

In one example, the WTRU may determine a constrained PMI based on any of the following: (i) a PMI with NES and/or performance constraints over any subset of macro TRPs (e.g., only), (ii) a PMI with NES and/or performance constraints over any subset of micro TRPs (e.g., only), (iii) a PMI with NES and/or performance constraints over any subset of macro and any subset of micro TRPs, and (iv) a PMI with NES/performance constraints over an anchor (main) macro and a subset of micro TRPs associated with the anchor macro, where the micro TRPs may have some (e.g., particular) relation with the macro TRP. For example, the micro TRPs may share the same distributed unit (DU) and/or control unit (CU) with the macro TRP. For example, the WTRU may know through configuration/signaling that micro TRPs may have backhaul links with the macro TRP of a specific nature, e.g., backhaul links with a certain quality, direct backhaul links etc.

WTRU estimation of performance loss for a constrained CJT PMI is described herein.

A WTRU may estimate (e.g. determine) a loss for a constrained PMI matrix. The WTRU determination of constrained PMI matrix may be according to any embodiment described herein.

The WTRU may be configured to determine (e.g., estimate) the loss for a constrained PMI based on any of the following metrics: (i) a loss in rank with constrained PMI, (ii) a loss in throughput with constrained PMI, (iii) a loss in energy where the energy may refer to the energy of the composite channel (the matrix of precoding and radio channel) with constrained PMI, (iv) a loss in sum of squared Eigen values of composite channel (precoding and radio channel) with constrained PMI, (v) a loss in the energy of the largest Eigen value of the composite channel with constrained PMI, and (vi) a loss in quality/reliability/CQI with constrained PMI.

The WTRU may determine a loss for a constrained PMI against (e.g., relative to) a suitable reference.

In one example, the reference may correspond to a configuration parameter or threshold value. For example, the WTRU may (e.g., be configured to) determine the loss for the constrained PMI based on the rank where a target rank may be provided as part of the configuration. In this case, the WTRU may determine the loss in rank with constrained PMI based on the rank of the determined constrained PMI and the configured target rank. The WTRU may determine the loss in rank, in this example, by subtracting the rank of the constrained PMI from the configured target rank.

In one example, the reference to estimate/determine the loss for a constrained PMI may be based on an unconstrained PMI, where the determination of the unconstrained PMI may be according to any embodiment described herein. As an example, the WTRU may (e.g., be configured to) determine the loss for the constrained PMI based on the rank against (e.g., relative to) the unconstrained PMI. In this case, the WTRU may determine the loss in rank with constrained PMI based on the rank of the determined constrained PMI and the rank of the determined unconstrained PMI. The WTRU may determine the loss in rank for the constrained PMI, in this example, by subtracting the rank of the constrained PMI from the rank of the unconstrained PMI. In one example, the WTRU may (e.g., be configured to) determine the loss for the constrained PMI based on the CQI against the unconstrained PMI. In this case, the WTRU may determine the loss in CQI with constrained PMI based on the CQI of the determined constrained PMI and the CQI of the determined unconstrained PMI. The WTRU may determine the loss in CQI for the constrained PMI, in this example, by subtracting the CQI of the constrained PMI from the CQI of the unconstrained PMI.

WTRU ranking/ordering of constrained CJT PMI is described herein.

A WTRU may perform ordering or ranking of the PMI matrices. The PMI matrices may correspond to the constrained PMI determined by the WTRU according to any embodiment described herein. The WTRU may perform ordering or ranking of the constrained PMI based on any of the following: (i) estimated/determined/expected performance loss where the determination of performance loss for a constrained PMI may be according to any embodiment described herein, (ii) estimated/determined/expected rank, (iii) estimated/determined/expected throughput, (iv) estimated/determined/expected reliability (e.g., CQI).

WTRU selection of constrained PMI is described herein.

A WTRU may select one or more constrained precoding matrices (PMIs). The WTRU may select one or more constrained PMIs from the set of computed constrained PMIs. The WTRU may select one or more constrained PMIs from the ranked/ordered PMIs where the ordering/ranking of the PMIs may be according to any embodiment described herein. The WTRU may select the top ranked constrained PMI(s) where the ranking/ordering may be according to any embodiment described herein.

The WTRU may select one or more constrained PMIs for CSI reporting. In one example, the WTRU may select (e.g., only) one top ranked PMI. This may, for example, be the case if the WTRU is configured to report one constrained PMI. In one example, the WTRU may select a number ‘n’ of top ranked constrained PMIs. This may, for example, be the case if the WTRU is configured to report ‘n’constrained PMIs.

In one example, the WTRU may determine to select one or more than one constrained PMI based on any of the following: (i) if there is one or multiple PMIs satisfying the NES constraints, (ii) if there is one or multiple PMIs satisfying the performance constraints, (iii) if there is one or multiple PMIs satisfying a certain criterion, e.g., rank, throughput, CQI etc.

The WTRU may select one or more constrained PMIs for CSI reporting purpose. In one example, the WTRU may select one or more constrained PMIs for UL transmission.

WTRU behavior is described herein when no constrained PMI satisfy NES and performance constraints simultaneously.

A WTRU may determine one or more PMIs based on RS measurements. The WTRU may determine a set of PMIs under a set of NES constraints according to any embodiment described herein. The WTRU may determine a set of PMIs under NES and performance (e.g., a target rank, a target CQI etc.) constraints. If the WTRU determines that none of the determined PMIs satisfy simultaneously NES and performance constraints, or if the WTRU cannot determine any PMI satisfying NES and performance constraints, the WTRU may perform any of the following operations.

In an example, if NES and performance constraints cannot be satisfied simultaneously, the WTRU may report the unconstrained PMI.

In an example, if NES and performance constraints cannot be satisfied simultaneously, the WTRU may report any of (i) the NES constrained PMI with smallest performance loss, e.g., smallest throughput loss compared to the unconstrained PMI, (ii) the NES constrained PMI with the largest CQI value, (iii) the NES constrained PMI with the largest rank, etc.

In an example, if NES and performance constraints cannot be satisfied simultaneously, the WTRU may relax the NES constraints. For example, the WTRU may relax the NES constraints if none of the determined PMI satisfy the performance constraints. The WTRU may perform any of the following: (i) increase the number of TRPs in the CJT set (e.g., the WTRU may increase the number of TRPs by one more than the nominal/baseline number of TRPs indicated by the network), (ii) increase the number of spatial domain basis beams per layer (e.g., the WTRU may increase the number of basis beams per layer by one more than the nominal/baseline number of spatial beam per layer configured by the network).

When the WTRU relaxes the NES constraints, the WTRU may re-compute the NES constrained PMIs under the relaxed NES constraints. The WTRU may then re-evaluate if the constrained PMIs satisfy the performance constraints. If they do, the WTRU may report the PMI to the network as per the reporting configuration. Otherwise, the WTRU may perform a number of iterations relaxing the NES constraints, until the WTRU may find the PMI satisfying the performance constraints or the number of iterations may have reached to a limit.

In an example, if NES and performance constraints cannot be satisfied simultaneously, the WTRU may relax the performance constraints: For example, the WTRU may relax the performance constraints if none of the determined PMIs satisfy the performance constraints. For example, the WTRU may relax the performance constraints if the WTRU has reached the limit on one or more parameters, e.g., the PMI computation may be using the upper bound (e.g., max) number of TRPs configured/indicated, or the PMI computation may be using the upper bound (e.g., max) number of spatial beams per layer, or the PMI computation may be using the upper bound (e.g., max) number of ports per layer. When the WTRU relaxes the performance constraints, the WTRU may perform any of the following: (i) reduce the target rank by one less than configured/indicated rank for which WTRU may be determining PMI, (ii) reduce the target CQI by a (e.g., configured) threshold, where the threshold applied may be according to a mapping table, in dB, or in any other suitable format, (iii) reduce the target rate/throughput/reliability etc. according to the provided configuration to determine PMI.

When the WTRU relaxes the performance constraints, the WTRU may re-evaluate the NES constrained PMI matrices under the relaxed performance constraints. If the constrained PMIs satisfy the relaxed performance constraints, the WTRU may report the PMI to the network as per the reporting configuration. Otherwise, the WTRU may perform a number of iterations relaxing performance constraints, until the WTRU may find the PMI satisfying the performance constraints or the number of iterations may have reached to a limit.

FIG. 3 is a diagram illustrating an example WTRU behavior when no precoding matrix satisfies the constraints.

As shown at 31, the WTRU may determine the set of constrained PMIs. As shown at 32, the WTRU may determine whether at least one PMI may be satisfying the NES and performance constraints.

If the WTRU determines that the computed PMI does not satisfy the NES and performance constraints simultaneously, the WTRU may determine to choose one or more of the following, e.g., move to reporting phase as shown at 310, re-compute PMI with relaxed NES constraints as shown at 320 and/or re-compute PMI with relaxed performance constraints as shown at 330, update (e.g., increase or decrease) the parameters with nominal values, e.g., nominal number of TRPs (e.g., macro or micro or both) and/or spatial beam and/or number of ports per layer etc. The WTRU determination of selecting a particular path, e.g., reporting or re-computing may be based on one or more conditions. In the example shown in FIG. 3, the WTRU moves to PMI reporting phase based on a first condition (referred to as condition 1) being satisfied. The first condition may be any of the following: (i) if network has configured the WTRU to report PMI when PMI does not satisfy the constraints, (ii) WTRU being a low capability WTRU, (iii) upon the expiry of a timer, (iv) upon reaching close to the PMI reporting deadline, e.g., when the PMI may be to be reported within/after a given number of symbols/slots, or in the units of time, e.g., ms, etc., (v) upon WTRU having iterated over an upper bound e.g., (max) number of PMI computations, (vi) upon PMI computation having reached the limits in terms of one or more parameters, e.g., WTRU unable to compute PMI (e.g., even with all TRPs), or WTRU unable to compute PMI meeting the constraints despite using (e.g., all) the antenna panels from the one/multiple/all TRPs, etc.

The second condition (referred to as condition 2) or the third condition (referred to as condition 3) may be based on network configuration, e.g., based on the WTRU having been configured to re-compute with relaxed NES constraints, or with relaxed performance constraints.

WTRU reporting of energy efficient CSI feedback for CJT is described herein.

WTRU reporting of constrained CJT PMI is described herein.

A WTRU may report CSI feedback based on CSI measurements. The CSI measurements may correspond to CSI transmitted from one or multiple TRPs. The CSI feedback may target multi-TRP transmission, e.g., multi-TRP CJT. The WTRU may report one or more constrained PMIs from the selected constrained PMI where the WTRU selection of constrained PMI may be according to any embodiment described herein.

WTRU reporting of unconstrained CJT PMI is described herein.

A WTRU may report CSI feedback for CJT. The WTRU may report CSI feedback for unconstrained PMI, where the WTRU determination/computation of unconstrained PMI may be according to any embodiment described herein.

WTRU reporting of performance loss for constrained CJT PMI is described herein.

A WTRU may report CSI feedback to the network. The reported CSI feedback may correspond to one or more constrained PMIs. The WTRU may report the performance loss for the reported PMI. The WTRU may determine to report the performance loss when the WTRU may report the constrained CJT PMI. The performance loss may be with respect to a configured parameter/threshold or with reference to the unconstrained PMI. The WTRU may report the loss based on the WTRU being configured to determine constrained CJT PMI and unconstrained PMI.

A WTRU may report the loss for constrained CJT PMI in any of absolute and relative terms. The loss may be reported as any of throughput, rate, rank, CQI, composite WH energy, eigen value, etc., where W refers to precoding matrix, H refers to estimated channel, and WH refers to composite channel matrix.

WTRU prioritization for different parts/components of CSI and transmission/dropping rules are described herein.

A WTRU may assign (e.g., determine) priorities for CSI. The WTRU may assign (e.g., determine) priorities for any of different parts of CSI, different components of CSI, different codebooks for CSI etc. The WTRU may assign (e.g., determine) priorities associated with different components/nature of CSI feedback. The WTRU may assign (e.g., determine) different priority values for CSI part 1 and CSI part 2. The WTRU may assign (e.g., determine) different priority values for constrained CSI/PMI Part 1 and unconstrained CSI/PMI Part1. The WTRU may assign (e.g., determine) different priority values for constrained CSI/PMI Part 2 and unconstrained CSI/PMI Part2. The WTRU may assign (e.g., determine) different values for constrained CSI/PMI Part 1/Part 2 of different PMI when the WTRU may be reporting more than one constrained PMI. The WTRU may assign (e.g., determine) priority value for different CSI/PMI based on any of the following: (i) the configuration, (ii) the rank of the reported PMI, e.g., the WTRU may assign higher priority value to higher rank PMI, (iii) the CQI of the reported PMI, e.g., the WTRU may assign higher priority value to higher reported CQI, (iv) the number of spatial beams used to determine the reported PMI, e.g., the WTRU may assign higher priority value to PMI computed with least/smaller number of spatial beams, (v) the estimated performance loss of the reported PMI against the unconstrained PMI (e.g., based on any of the estimated loss in rank, estimated loss in CQI, estimated loss in throughput, estimated loss in energy, etc.) as an example, the WTRU may assign a higher priority value for PMI with smaller/smallest loss etc., the WTRU may determine quantized intervals of loss metric which may be assigned a (e.g., given) priority value, (vi) the estimated performance loss of the reported PMI against configured thresholds e.g., based on any of the estimated loss in rank, estimated loss in CQI, estimated loss in throughput, estimated loss in energy, etc., (vii) the difference of number of spatial beams used to determine the reported PMI and the nominal number of spatial beams.

The WTRU may report the CSI in order of the assigned/configured priority values of the CSI components, e.g., the higher/highest priority components may be transmitted first e.g., when all CSI parts/components may not be transmitted e.g., due to limited transmission resource.

The WTRU may drop the CSI in order of the assigned/configured/determined priorities of the CSI components, e.g., the lower/lowest priority components may be dropped first e.g., when all CSI parts/components may not be transmitted e.g., due to limited transmission resource.

An example network energy efficient CSI feedback method for multi-TRP coherent transmissions is described herein.

For multi-TRP based coherent joint transmissions, a WTRU may measure the CSI-RS from a set of TRPs. For CSI feedback, the WTRU may determine (e.g., compute) the precoding matrices satisfying a bounded performance difference compared to an unconstrained CJT precoding matrix and any of (i) the TRP level energy saving (e.g., using a (e.g., min) number of TRPs for CJT), (ii) the antenna panels energy saving (e.g., the (e.g., min) number of antenna panels) per TRP and (iii) the spatial beams-per-layer energy saving (e.g., using a (e.g., minimal) number of spatial basis beams per layer) for a specific rank/CQI.

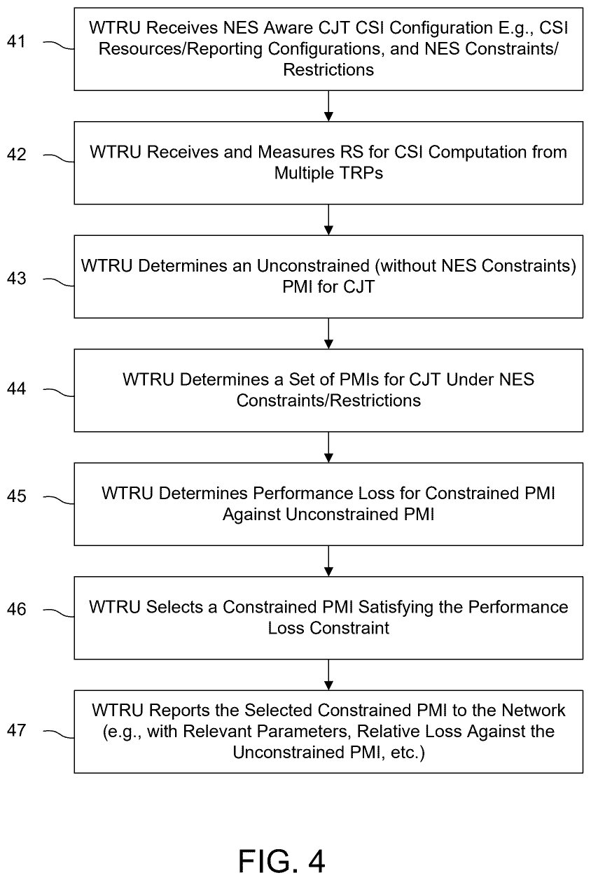

FIG. 4 is a diagram illustrating an example method for NES aware CSI computation and reporting for coherent joint transmissions (CJT), in a WTRU.

As shown at 41, the WTRU may receive network configuration information to provide CSI feedback for coherent joint transmission from a plurality of TRPs (comprising a (e.g., total) number of TRPs referred to herein as M1, where the TRPs may (e.g., each) include a total (e.g., max) number of antenna panels (referred to P1). The network configuration information may indicate any of the following: (a) one or more RSs (e.g., CSI-RSs) for CSI measurements and feedback associated with a (e.g., each TRP), for the plurality of M1 TRPs and an upper bound (e.g., max) number of spatial domain (SD) beams per layer (referred to herein as SD_max), (b) a first constraint (referred to as C1) e.g., indicating a number of TRPs (e.g., a nominal number of TRPs to start computing CJT PMI and lower than M1), (c) a second constraint (referred to as C2) e.g., indicating a number of antenna panels per TRP (e.g., a nominal number of antenna panels per TRP to start computing PMI and lower than P1), (d) a third constraint (referred to as C3) e.g., indicating a number of spatial beams per layer (e.g., a nominal number of spatial beams per layer to start computing CJT PMI matrix and lower than SD_max), (e) a target rank-referred to as R) e.g., indicating that the reported rank of the pre-coding matrix may not be less than a threshold R), (f) a performance loss constraint (PLC) e.g., indicating that the estimated performance loss of the constrained precoding matrix with regards to the unconstrained precoding matrix may be less than a threshold PLC, where the performance loss may correspond to any of the throughput difference, energy difference of WH or energy difference of the largest Eigen value, etc., where W refers to a precoding matrix, H refers to an estimated channel, and WH refers to a composite channel matrix, (g) a reliability restriction (e.g., referred to as C) e.g., indicating that the CQI associated with the reported pre-coding matrix may exceed a threshold C, (h) a number n of joint pre-coding matrices to report where n may be configured as any of the lower bound (e.g., min), the upper bound (e.g., max), and precise number of reported pre-coding matrices (e.g., 1, 2, . . . ).

As shown at 42, the WTRU may receive and measure RSs transmitted by M1 TRPs, as per the received network configuration information.

As shown at 43, the WTRU may determine an unconstrained (ignoring C1, C2 and C3, e.g., using the M1 TRPs, the total number of (e.g., all) antenna panels (P1) and SD_max spatial basis beams) precoding matrix for coherent joint transmission from the M1 TRPs, based on the measurements.

As shown at 44, the WTRU may determine a set of constrained precoding matrices for coherent joint transmission satisfying any of C1 (e.g., using the nominal number of TRPs), C2 (e.g., using the nominal number of antenna panels) and C3 (e.g., using the nominal number of SD basis beams) constraints.

As shown at 45, the WTRU may determine (e.g., estimate) the performance loss for a (e.g., each) constrained precoding matrix with regards to the unconstrained precoding matrix.

As shown at 46, the WTRU may select the constrained precoding matrix satisfying the performance loss constraint. If no constrained precoding matrix of the set of constrained precoding matrices satisfies the performance loss constraint, the WTRU may increase the number of TRPs, and/or the number of antenna panels and/or the number of SD basis beams to re-compute the set of constrained precoding matrices beyond C1/C2/C3 until a suitable PMI or M1 TRPs/P1 antenna panels/SD_max may be reached).

As shown at 47, the WTRU may report any of the determined constrained precoding matrix, associated parameters (e.g., any of TRPs, antenna panels, basis beams, amplitude, phase, angle coefficients etc. in the PMI) and relative performance loss to the network.

The example method for NES aware CSI computation and reporting for CJT may allow the network to save energy by using the “most energy efficient” TRPs/antenna panels/spatial beams in the active set of CJT matrix which may be used to transmit data coherently to a WTRU.

The network energy saving may be achieved while keeping CJT within a bounded/controlled performance margin from an unconstrained CJT.

An example network energy efficient CSI feedback method for single TRP transmissions is described herein.

For single TRP DL transmissions, a WTRU may measure the CSI-RS from a TRP. For CSI feedback, the WTRU may compute the precoding matrices satisfying any of the energy saving constraints e.g., (i) the antenna panels (e.g., the (e.g., min) number of antenna panels) and (ii) the spatial beams-per-layer (e.g., the spatial basis beams minimized) for a specific rank/CQI and bounded performance difference compared to an unconstrained precoding matrix.

In an example, the WTRU may receive network configuration information to provide CSI feedback for downlink transmission from a TRP, comprising/indicating any of the following: (a) one or more RSs (e.g., CSI-RSs) for CSI measurements and feedback, (b) a first constraint e.g., indicating a number of antenna panels (e.g., a nominal number of antenna panels to start computing PMI), (c) a second constraint e.g., indicating a number of spatial beams per layer (e.g., a nominal number of spatial beams per layer to start computing PMI matrix), (d) a target rank (referred to as L) e.g., indicating that the reported rank of the precoding matrix may not be less than a threshold L, (e) a performance loss constraint (e.g., indicating that the estimated performance loss of the constrained precoding matrix with regards to the unconstrained precoding may be less than a threshold, where the performance loss may correspond to the energy difference of WH or energy of the largest Eigen value, etc., where W refers to a precoding matrix, H refers to an estimated channel, and WH refers to a composite channel matrix), (f) a reliability restriction (referred to as C) e.g., indicating that the CQI associated with the reported precoding matrix may exceed a threshold C, (g) a number n of precoding matrices to report where n may be configured as any of the lower bound (e.g., min) the upper bound (e.g., max) and precise number of reported precoding matrices (e.g., 1).

In an example, the WTRU may receive, and measure RSs transmitted by the TRP, as per the received network configuration information.

In an example, the WTRU may determine an unconstrained (ignoring the first constraint and the second constraint) precoding matrix for DL transmission, based on the measurements.

In an example, the WTRU may determine a set of constrained precoding matrices for DL transmission based on any of the first constraint (nominal number of antenna panels) and the second constraint (nominal number of SD basis beams).

In an example, the WTRU may determine (e.g., estimate) the performance loss for a (e.g., each) constrained precoding matrix with regards to the unconstrained precoding matrix.

In an example, the WTRU may select the constrained precoding matrix from the set of constrained precoding matrices satisfying the performance loss constraint. If no constrained precoding matrix satisfies the performance loss constraint, the WTRU may increase the number of antenna panels and/or SD basis beams to re-compute the set of constrained pre-coding matrices

In an example, the WTRU may report any of the determined constrained precoding matrix, associated parameters (any of antenna panels, basis beams) and relative performance loss to the network.

The network energy efficient CSI feedback method for single TRP transmissions described herein may allow a WTRU to report CSI so as to reduce (e.g., minimize) the number of active antenna panels and/or number of spatial beams per layer for single TRP based DL transmissions while satisfying a bounded rank/throughput.

An example network energy efficient CSI feedback method for multi-TRP CJT in heterogenous TRP deployments is described herein.

For coherent joint transmissions in heterogeneous TRP deployments comprising, for example, one or more macro TRPs (e.g., always on TRPs to provide coverage) and micro (e.g., femto) TRPs (e.g., opportunistically on TRPs for capacity), a WTRU may measure the CSI-RS from macro and micro TRPs. For CSI feedback, the WTRU may compute the CJT precoding matrices over macro TRPs and a lower bound (e.g., minimal) number of micro TRPs (to enable deep sleep) satisfying the TRP level and spatial-beams-per-layer level constraints.

In an example, the WTRU may receive network configuration information to provide CSI feedback (e.g., the joint precoding matrices) for coherent joint transmission from (i) a plurality of macro TRPs (e.g., comprising a (e.g., total) number of macro TRPs referred to herein as M1) and (ii) a plurality of micro TRPs (e.g., comprising a (e.g., total) number of micro TRPs referred to herein as m1).

The network configuration information may indicate any of the following: (a) one or more RSs (e.g., CSI-RSs) for CSI measurements and feedback associated with a (e.g., each) TRP, (b) a TRP level energy saving restriction (e.g., to be used to compute the constrained precoding matrices for CJT), where the TRP level energy saving restriction may indicate any of the following: (i) PMI with macro TRPs and least number of micro TRPs, (ii) PMI with macro TRPs and at most a number (referred to as m2) of micro TRPs, (iii) PMI with at least one macro TRP and at most a number (referred to as M2) of macro TRPs, (c) a spatial beams-per-layer level energy saving restriction e.g., indicating any of (i) that the number of spatial beams-per-layer may not exceed a first number (referred to as L) of basis beams, (ii) that the number of spatial beams-per-layer from macro TRPs may not exceed a second number (referred to as L_M) of basis beams, and (iii) that the number of spatial beams-per-layer from micro TRPs may not exceed a third number (referred to as l_m) of basis beams, (d) a rank restriction (referred to as R) e.g., indicating that the overall rank of the reported precoding matrix may exceed a threshold R, (e) a reliability restriction (referred to as C) e.g., indicating that the CQI associated with the reported precoding matrix may exceed a threshold C), and (f) a number n of joint pre-coding matrices to report where n may be configured as any of the lower bound (e.g., min), upper bound (e.g., max) and precise number of reported matrices (e.g., 1, 2, etc.).

In an example, the WTRU may receive, and measure RSs transmitted by the TRPs, as per the received network configuration information.

In an example, the WTRU may determine two reference pre-coding matrices: a first unconstrained (best) precoding matrix for coherent joint transmission over (e.g., all) TRPs (including the plurality of macro TRPS and the plurality of micro TRPs) and a second unconstrained (best) precoding matrix over (e.g., all) macro TRPs, based on the measurements.

In an example, the WTRU may determine a set of constrained (best) precoding matrices for coherent joint transmission satisfying any of the TRP level and spatial beams-per-layer level constraints.

In an example, the WTRU may determine (e.g., estimate) the performance loss/degradation for a (e.g., each) constrained precoding matrix with regards to (e.g., any of) the two reference pre-coding matrices, where the performance degradation may correspond to relative loss in rank/CQI/throughput/reliability for the constrained precoding matrix.

In an example, the WTRU may determine a number n of constrained precoding matrices with least performance degradation.

In an example, the WTRU may report any of the determined constrained precoding matrices with TRP identities and relative performance loss to the network.

The network energy efficient CSI feedback method for multi-TRP CJT in heterogenous TRP deployments may allow the network to save energy by putting the micro (opportunistically on) TRPs to lower energy state or completely turned off while macro TRPs may be used for coherent transmissions as long as they may meet (e.g., certain) QoS.

A heterogeneous network may comprise a set of macro TRPs and another set of micro TRPs. The network may be using macro TRPs for coverage reasons, such that the macro TRPs may be always on. The network may be using the micro TRPs as capacity boosting TRPs, such that they may (e.g., only) be opportunistically on.

In an example, a WTRU may be configured with CSI measurements and reporting for the neighboring macro and micro TRPs.

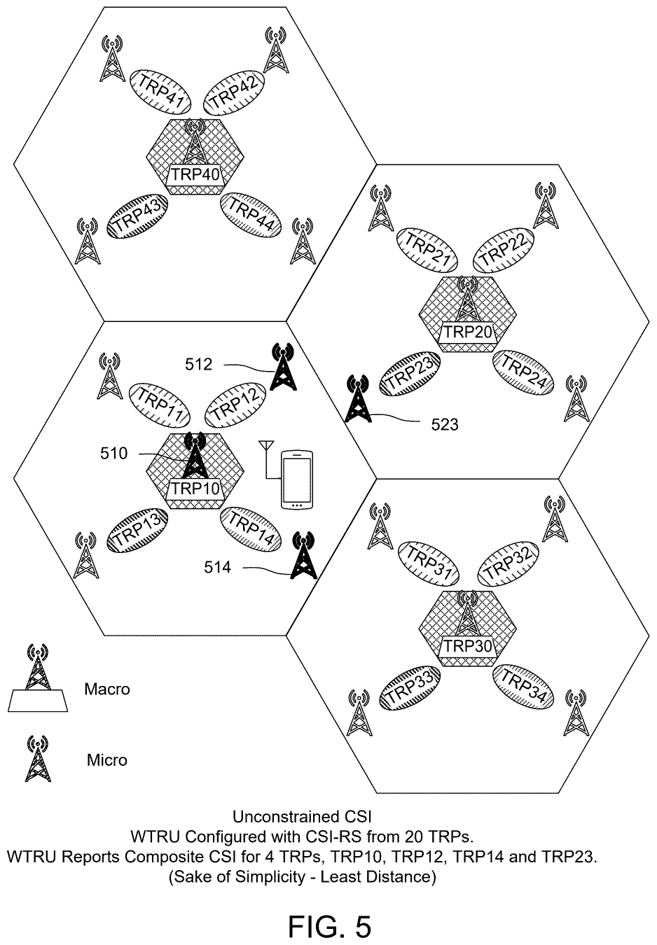

FIG. 5 is a diagram illustrating a scenario where a WTRU may provide CSI/PMI feedback for multi-TRP transmission to the network, e.g., in a legacy situation. In an example, the network may configure the WTRU to provide PMI for joint transmission using four TRPs. The WTRU may report PMI using the following four (e.g., closest) TRPs, TRP10 510 (the closest macro TRP), TRP12 512 (micro), TRP14 514 (micro), TRP23 523 (micro). This may be under the assumption that the best radio links may be the ones closest to the WTRU. These TRPs are shown in black while the other TRPs are greyed out. The WTRU reported PMI may be best from WTRU performance/throughput perspective. If the network is in low load situation, the network may expect to turn off the micro TRPs to sleep. The network may be keeping the WTRU reported micro TRPs on, which may be very inefficient for network energy consumption.

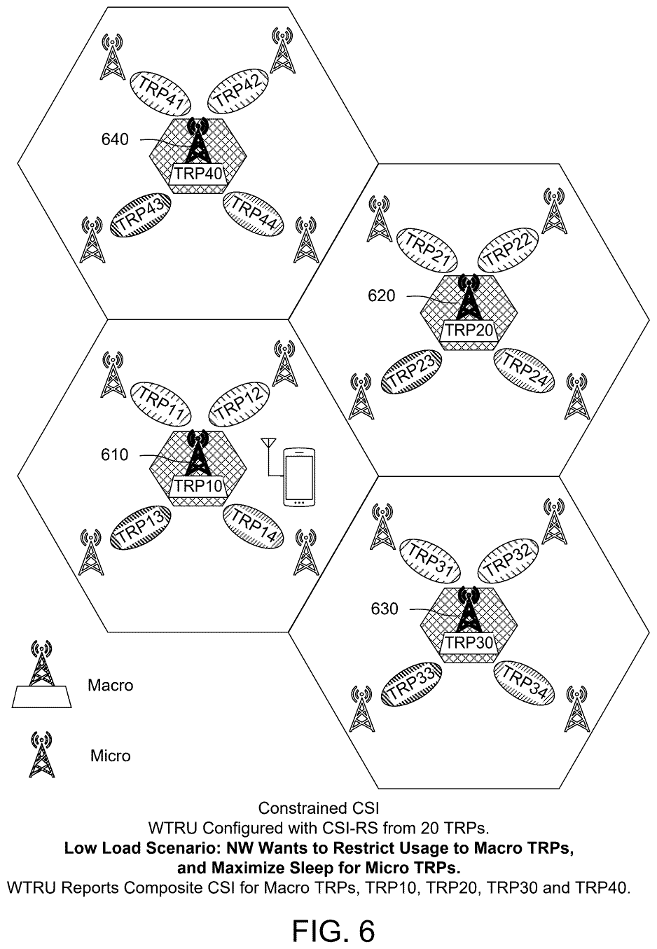

FIG. 6 is a diagram illustrating a low load scenario where a WTRU may provide network energy efficient (e.g., constrained) CSI/PMI feedback for multi-TRP transmission. FIG. 6 illustrates the same layout for macro and micro TRPs and WTRU location as FIG. 5. The network may configure the WTRU with PMI TRP level restrictions according to any embodiment described herein. Based on the configuration restriction to prioritize macro TRPs if performance constraints are met, the WTRU may provide PMI report over four macro TRPs, namely, TRP10 610, TRP20 620, TRP30 630, TRP40 640. This may imply some compromise on the WTRU throughput, and may enable huge network energy saving, as the network may not (e.g., need to) turn on micro TRPs, contrary to the previous case shown at FIG. 5.

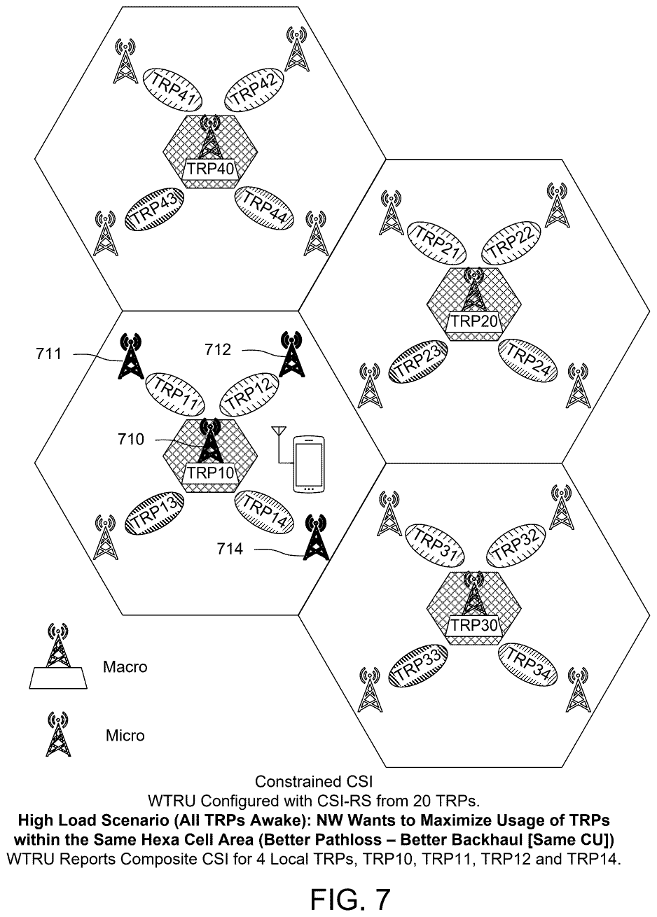

FIG. 7 is a diagram illustrating a high load scenario where a WTRU may provide network energy efficient (e.g., constrained) CSI/PMI feedback for multi-TRP transmissions. FIG. 7 shows the same layout for macro and micro TRPs and WTRU location, as FIG. 5 and FIG. 6, targeting a scenario under high network load conditions. Under high load conditions, more (e.g., all the) micro TRPs may be fully awake. In an example, the network may like to prioritize the use of micro TRPs in the WTRU vicinity for multi-TRP transmissions. In addition, some (e.g., micro) TRPs may have better backhaul to macro TRP, e.g., the TRPs in the same hexagonal cell area. This may be based on the micro TRPs sharing the same control unit (CU) with the macro TRP of the hexagonal cell area (e.g., or for another reason). Under the network constraints, the WTRU may report the PMI matrix for the TRPs in the same cell including, for example, the following TRPs: TRP10 (macro) 710, TRP11(micro) 711, TRP12 (micro) 712, TRP14 (micro) 714. Embodiments described herein may allow the network to configure the WTRU for different network layouts and load conditions and may result in considerable network energy savings with controlled/bounded WTRU performance impact.

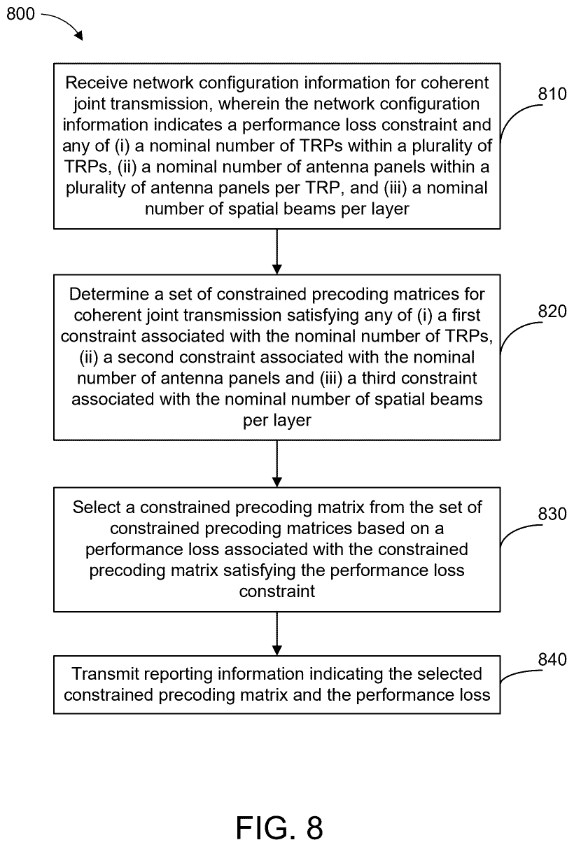

FIG. 8 is a diagram illustrating an example method 800 for NES aware CSI feedback for multi-TRP transmissions. As shown at 810, the method 800 may include receiving network configuration information for coherent joint transmission. In various embodiments, the network configuration information may indicate a performance loss constraint and any of (i) a nominal number of transmit/receive point (TRPs) within a plurality of TRPs, (ii) a nominal number of antenna panels within a plurality of antenna panels per TRP, and (iii) a nominal number of spatial beams per layer. As shown at 820, the method 800 may include determining a set of constrained precoding matrices for coherent joint transmission satisfying any of (i) a first constraint associated with the nominal number of TRPs, (ii) a second constraint associated with the nominal number of antenna panels and (iii) a third constraint associated with the nominal number of spatial beams per layer. As shown at 830, the method 800 may include selecting a constrained precoding matrix from the set of constrained precoding matrices based on a performance loss associated with the constrained precoding matrix satisfying the performance loss constraint. As shown at 840, the method 800 may include transmitting reporting information indicating the selected constrained precoding matrix and the performance loss.

In various embodiments, the nominal number of TRPs may be lower than a total number of TRPs in the plurality of TRPs. In various embodiments, the nominal number of antenna panels for a TRP may be lower than a total number of antenna panels in the plurality of antenna panels for the TRP. In various embodiments, the nominal number of spatial beams per layer may be lower than a total number of spatial beams per layer.

In various embodiments, the set of constrained precoding matrices may satisfy the first constraint associated with the nominal number of TRPs on condition that constrained precoding matrices of the set of constrained precoding matrices use a number of TRPs higher than or equal to the nominal number of TRPs.

In various embodiments, the set of constrained precoding matrices may satisfy the second constraint associated with the nominal number of antenna panels per TRP on condition that constrained precoding matrices of the set of constrained precoding matrices use a number of antenna panels per TRP higher than or equal to the nominal number of antenna panels per TRP.

In various embodiments, the set of constrained precoding matrices may satisfy the third constraint associated with the nominal number of spatial beams per layer on condition that constrained precoding matrices of the set of constrained precoding matrices use a number of spatial beams per layer higher than or equal to the nominal number of spatial beams per layer.

In various embodiments, the network configuration information may further indicate one or more reference signals for channel state information measurement associated with any of the total number of TRPs, the total number of antenna panels and the total number of spatial beams.

In various embodiments, the method 800 may further include receiving the one or more reference signals and performing measurement of the one or more reference signals.

In various embodiments, the method 800 may further include determining an unconstrained precoding matrix using the measurement of the one or more reference signals from any of the total number of TRPs, the total number of antenna panels and the total number of spatial beams per layer.

In various embodiments, the method 800 may further include determining the performance loss associated with the selected constrained precoding matrix relative to the unconstrained precoding matrix.

In various embodiments, the performance loss constraint may be satisfied for the performance loss associated with the selected constrained precoding matrix on condition that the performance loss is below a threshold.

In various embodiments, determining the set of constrained precoding matrices may comprise determining the set of constrained precoding matrices based on the measurement of the one or more reference signals.

In various embodiments, the plurality of TRPs may comprise a plurality of macro TRPs and a plurality of micro TRPs. In various embodiments, the network configuration information may further indicate a fourth constraint associated with any of a nominal number of macro TRPs within the plurality of macro TRPs and a nominal number of micro TRPs within the plurality of micro TRPs.

In various embodiments, determining the set of constrained precoding matrices may comprise determining the set of constrained precoding matrices satisfying the fourth constraint.

In various embodiments, the set of constrained precoding matrices may satisfy the fourth constraint associated with any of the nominal number of macro TRPs and the nominal number of micro TRPs on condition that constrained precoding matrices of the set of constrained precoding matrices use a number of macro TRPs higher than or equal to the nominal number of macro TRPs.

In various embodiments, the set of constrained precoding matrices may satisfy the fourth constraint associated with any of the nominal number of macro TRPs and the nominal number of micro TRPs on condition that constrained precoding matrices of the set of constrained precoding matrices use a number of micro TRPs lower than or equal to the nominal number of micro TRPs.

In various embodiments, macro TRPs may be associated with a larger coverage area.

In various embodiments, micro TRPs may be associated with a lower coverage area.

In various embodiments, the micro TRPs may be opportunistically switched on to increase a network capacity.

While not explicitly described, embodiments described herein may be employed in any combination or sub-combination. For example, the present principles are not limited to the described variants, and any arrangement of variants and embodiments can be used.

Besides, any characteristic, variant or embodiment described for a method is compatible with an apparatus device comprising means for processing the disclosed method, with a device comprising circuitry, including any of a transmitter, a receiver, a processor, and memory, the circuitry being operable (e.g., configured) to process the disclosed method, with a computer program product comprising program code instructions and with a non-transitory computer-readable storage medium storing program instructions. Besides, any characteristic, variant or embodiment described for a WTRU is compatible with an (e.g., infrastructure) network element of the cellular network.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

The content of each of the following references is incorporated by reference herein in its entirety:
Third generation partnership project (3GPP), “Technical Specification Group Radio Access Network; NR; Medium Access Control (MAC) protocol specification (Release 17)”, 3GPP TS 38.321V 17.2.0, September 2022,

What is claimed is:

1. A wireless transmit/receive unit (WTRU) comprising circuitry, including any of a transmitter, a receiver, a processor, and memory, configured to:
receive network configuration information for coherent joint transmission, wherein the network configuration information indicates a performance loss constraint and any of (i) a nominal number of transmit/receive point (TRPs) within a plurality of TRPs, (ii) a nominal number of antenna panels within a plurality of antenna panels per TRP, and (iii) a nominal number of spatial beams per layer;
determine a set of constrained precoding matrices for coherent joint transmission satisfying any of (i) a first constraint associated with the nominal number of TRPs, (ii) a second constraint associated with the nominal number of antenna panels and (iii) a third constraint associated with the nominal number of spatial beams per layer;
select a constrained precoding matrix from the set of constrained precoding matrices based on a performance loss associated with the constrained precoding matrix satisfying the performance loss constraint; and
transmit reporting information indicating the selected constrained precoding matrix and the performance loss.

2. The WTRU of claim 1, wherein the nominal number of TRPs is lower than a total number of TRPs in the plurality of TRPs, wherein the nominal number of antenna panels for a TRP is lower than a total number of antenna panels in the plurality of antenna panels for the TRP and wherein the nominal number of spatial beams per layer is lower than a total number of spatial beams per layer.

3. The WTRU of claim 1, wherein the set of constrained precoding matrices satisfy the first constraint associated with the nominal number of TRPs on condition that constrained precoding matrices of the set of constrained precoding matrices use a number of TRPs higher than or equal to the nominal number of TRPs.

4. The WTRU of claim 1, wherein the set of constrained precoding matrices satisfy the second constraint associated with the nominal number of antenna panels per TRP on condition that constrained precoding matrices of the set of constrained precoding matrices use a number of antenna panels per TRP higher than or equal to the nominal number of antenna panels per TRP.

5. The WTRU of claim 1, wherein the set of constrained precoding matrices satisfy the third constraint associated with the nominal number of spatial beams per layer on condition that constrained precoding matrices of the set of constrained precoding matrices use a number of spatial beams per layer higher than or equal to the nominal number of spatial beams per layer.

6. The WTRU of claim 2, wherein the network configuration information further indicates one or more reference signals for channel state information measurement associated with any of the total number of TRPs, the total number of antenna panels and the total number of spatial beams.

7. The WTRU of claim 6, further configured to receive the one or more reference signals and to perform measurement of the one or more reference signals.

8. The WTRU of claim 7, further configured to determine an unconstrained precoding matrix using the measurement of the one or more reference signals from any of the total number of TRPs, the total number of antenna panels and the total number of spatial beams per layer.

9. The WTRU of claim 8, further configured to determine the performance loss associated with the selected constrained precoding matrix relative to the unconstrained precoding matrix.

10. The WTRU of claim 9, wherein the performance loss constraint is satisfied for the performance loss associated with the selected constrained precoding matrix on condition that the performance loss is below a threshold.

11. The WTRU of claim 1, wherein being configured to determine the set of constrained precoding matrices comprises being configured to determine the set of constrained precoding matrices based on the measurement of the one or more reference signals.

12. The WTRU of claim 1, wherein the plurality of TRPs comprises a plurality of macro TRPs and a plurality of micro TRPs, and wherein the network configuration information further indicates a fourth constraint associated with any of a nominal number of macro TRPs within the plurality of macro TRPs and a nominal number of micro TRPs within the plurality of micro TRPs.

13. The WTRU of claim 12, wherein being configured to determine the set of constrained precoding matrices comprises being configured to determine the set of constrained precoding matrices satisfying the fourth constraint.

14. The WTRU of claim 13, wherein the set of constrained precoding matrices satisfy the fourth constraint associated with any of the nominal number of macro TRPs and the nominal number of micro TRPs on condition that constrained precoding matrices of the set of constrained precoding matrices use a number of macro TRPs higher than or equal to the nominal number of macro TRPs.

15. The WTRU of claim 13, wherein the set of constrained precoding matrices satisfy the fourth constraint associated with any of the nominal number of macro TRPs and the nominal number of micro TRPs on condition that constrained precoding matrices of the set of constrained precoding matrices use a number of micro TRPs lower than or equal to the nominal number of micro TRPs.

16. The WTRU of claim 12, wherein macro TRPs are associated with a larger coverage area.

17. The WTRU of claim 12, wherein micro TRPs are associated with a lower coverage area.

18. The WTRU of claim 17, wherein the micro TRPs are opportunistically switched on to increase a network capacity.

19. A method implemented in a wireless transmit/receive unit (WTRU), comprising:
receiving network configuration information for coherent joint transmission, wherein the network configuration information indicates a performance loss constraint and any of (i) a nominal number of transmit/receive point (TRPs) within a plurality of TRPs, (ii) a nominal number of antenna panels within a plurality of antenna panels per TRP, and (iii) a nominal number of spatial beams per layer;
determining a set of constrained precoding matrices for coherent joint transmission satisfying any of (i) a first constraint associated with the nominal number of TRPs, (ii) a second constraint associated with the nominal number of antenna panels and (iii) a third constraint associated with the nominal number of spatial beams per layer;
selecting a constrained precoding matrix from the set of constrained precoding matrices based on a performance loss associated with the constrained precoding matrix satisfying the performance loss constraint; and
transmitting reporting information indicating the selected constrained precoding matrix and the performance loss.

20. The method of claim 19, wherein the nominal number of TRPs is lower than a total number of TRPs in the plurality of TRPs, wherein the nominal number of antenna panels for a TRP is lower than a total number of antenna panels in the plurality of antenna panels for the TRP and wherein the nominal number of spatial beams per layer is lower than a total number of spatial beams per layer.
